(19) United States
(12) Patent Application Publication
(10) Pub. No.: US 2009/0187425 A1
(43) Pub. Date: Jul. 23, 2009

(54) PDA software robots leveraging past history in seconds with software robots

(76) Inventor: Arthur Solomon Thompson, Reston, VA (US)

Correspondence Address: Arthur Solomon Thompson, Apt PH 1, 11904 Winterthur Lane, Reston, VA, 20191, US

(21) Appl. No.: 12/232,335

(22) Filed: Sep. 16, 2008

Related U.S. Application Data
(60) Provisional application No. 60/960,103, filed on Sep. 17, 2007.

(51) Int. Cl. G06Q 50/00; G06F 7/08; G06F 15/18; G06F 15/16; G06N 5/02; G06G 7/60; G06G 7/48; G06F 17/30; G06F 17/20; G06F 9/44; G06G 7/76; G06N 3/12; G06Q 10/00; G06F 11/07; G06F 3/048; G06F 17/27; G10L 15/26; H04L 29/06; H04M 1/00; G06F 19/00

(52) U.S. Cl. 705/3; 707/6; 706/10; 706/12; 709/202; 706/46; 703/11; 703/7; 707/7; 706/52; 706/11; 717/101; 701/118; 706/13; 707/4; 705/9; 714/746; 715/772; 707/5; 704/8; 704/9; 704/235; 455/414.3; 455/556.2; 702/19; 714/E11.023; 707/E17.032; 707/E17.014; 707/E17.015; 707/E17.017; 707/E17.009; 704/E15.043

(57) ABSTRACT

The International market is a vital horizon for todays and future strategies since it provides a robust and competitive arena for expanding business. The focus of the forgoing is to deploy a suite of decision search tools which will live on the phone network and the internet. The prime focus is to mainstream an electronic data record and medical diagnostic application [telephone/internet deployment architecture] which will address one of the most threatening problems in America “Mainstreaming of remote Health Care Services Access”. These tools will primarily be used to determine the severity of health condition providing Doctor Collaboration and health services routing.

We spend 1.6 trillion dollars in health care cost and have not realized full efficiency primarily based on access, infrastructure, doctor shortage, rising prices and technology issues. The theme here involves deploying a health care international alliance which will not only address national but international health care needs.

The marriage of decision support technology and Nano implementation will be a powerful tool in addressing health care and other feedback technology that can live on our telecommunications network. Preliminary assessment indicates that the data structure should be able to support 10s of millions of medical records in addition to leveraging decades of medical history in seconds. It should also be noted that the architecture supports a number of decision and games system applications as outlined in further documentation.

It appears that one of the enabling technologies that are promoting an intelligent look and feel by software system involves leveraging past history in seconds. This sublime but inertial characteristic provides the ability of decades of information to be searched and realized in such fields as medical critical care or emergency response units.

This specification claims the benefit of filing data of Provisional application 60/960,103 filed Sep. 17, 2007

### BACKGROUND OF THE INVENTION

This specification contains no new information since the annotations were derived from the drawing document per 37 CFR 1.125 (b)

The International Medical Expert Diagnosis (IMED) architecture excels in offering services since it is poised for pattern recognition and leveraging past history in seconds per requirements of Artificial Intelligence.

The International arena is a vital horizon for future market strategies since it provides a competitive arena for expanding business. The focus of the forgoing is to deploy a suite of decision search tools which will live on the phone network and the internet. The forgoing deploys Telephone software robot and expert system technology as a mean of drastically increasing the process efficiency of a large variety of tasks. One of the prime focus is to implement and integrate electronic data record and medical diagnostic advisory services in an international forum leveraging a multilingual approach. These tools will primarily be used to determine the severity of patent health conditions providing physician routing based on medical symptoms and electronic medical data history.

We spend 2.4 trillion dollars in health care costs and have not realized full efficiency primarily based on lack of access, poor infrastructure, doctor shortage, rising prices and technology issues. The proposed technology actually addresses most of these deficiencies in the current health care delivery system incorporating processes which should introduce substantial increases in targeted patient care along with strategies to extend service delivery internationally in a multi-lingual manner.

The marriage of decision support technology and telecommunications conduits like the phone & internet will be powerful tools in a variety of service based sectors, like health care, enterprise resource planning, traffic control and loan processing to name a few. Preliminary assessment indicates that the International Medical Expert Diagnosis should be able to support 10 s of millions of medical records in addition to leveraging decades of medical history in seconds. It should also be noted that the architecture supports a number of decision and games system applications as outlined in further documentation.

Expert System Shell technology can redefine how applications are developed and deployed in the current information technology forum. The extremely powerful and robust architecture provides extraordinary computing power and information search which could catapult us into an information era of software robots and intelligent agent brokers. This patent identifies a core of applications which may have immediate traction in our current struggle for information assurance and viability by leveraging a games architecture as the fundamental building block for expert system capability. It is key that tangible benchmarks of increased performance are used to demonstrate the inertia of software robot technology in the area of process optimization and search.

Search Efficiency

It would probably take 60 years to search for a set of symptoms (frequencies) in a database of potentially 2 billion electronic medical records (versus 2 billion phone numbers). Identifying a matching electronic medical record would provide a prior treatment plan that was established by some physician anywhere in the world. By leveraging past medical history in seconds, IMED on the phone provides the latter search propensity, which is congruent to pattern matching a ten digit phone number on the phone system. The boost in efficiency is almost immeasurable since the aforementioned search is done in a little over a second.

The novelty that has been brought to the table extends traditional computing into an era of intelligent brokers capable of learning mundane or extremely—complex processes which can leverage centuries of past history in order to reconcile very precise search initiatives. The focus here will be to present a new approach to health care deployment and mainstreaming that will provide overwhelming capability for end users to acquire information transparently and provide the ability to obtain Physician and medical assistance within timely schedule by routing patients to appropriate physician. The ambitious objective for turn around reliability will be postulated based on a state of the art quality assurance network and expert system which streamlines the electronic medical records and diagnosis process, international community of doctors which could facilitate affordable care for those who don't have insurance.

International Medical Expert Diagnosis ultimately could provide a variety of international multi-lingual services by leveraging software robots which will facilitate lists of numerical medical data which can be converted to any language transparently.

Electronic Medical Record Software Robot

Health Care Services

International Medical Expert Diagnosis key Features
Electronic Medical Record
Diagnosis Advisory Services
Physician Routing based on Patient Symptom
Physician Differential Diagnosis
Critical Care Software Robots with symptom knowledge base of Emergency encounters
Physician Determination of History Treatment plan by inputting Recent Diagnostic String
When diagnosing new ailments system leverages decades of medical history in seconds affording review of complete medical history
Substantially Increase the capability of physicians to manage a much greater number of patients reliably leveraging a profile classification system.
Dramatically lower malpractice insurance by the collaboration committee approach.
Increase Health Care Information Systems revenues by International service engagement and reinvestment in American Health Care System
Provide for a 24/7 approach to medical assistance and services.
Substantially leverage decades of patient past history within seconds as a key strategy in detecting and fighting illnesses.
Early detection through easy access should lower overall Health Care treatment cost
Electronic medical data available on PDA device which is updated by new illness signatures from internet facilitating convenient easy access.
Phone and internet access on the PDA facilitates easy information access which is down loadable to computer, physician or health care entity for further communications and analysis of options
Very low cost option for symptom diagnosis actually leveraging the patient's entire medical history and recommendation for seeking professional help.
Although the system cannot legally propose specific patient treatment recommendation, it captures a large history of patient treatment strategies and diagnosis that can be made available to participating physicians.
Main goal of the system is to provide accurate, fast and convenient referral information to empower patients to get quick access to health care alternative and eliminate the generic latency in the health care mechanism.
Unsurpassed search and storage technology provides for search very large search space for various viruses, bacteria based pattern matching of symptoms and leveraging quickly medical historical information.
Multi lingual capability for all languages is based on numeric format of diagnostic strings of other information deliverables.
Internationally poised medical health care delivery access strategy designed to reach hundreds of millions of customers.

Software Robots on PDA ″Architecture will support interactive
communication

Interactive Language and Comprehension (Leveraging Decades of Past History in Seconds-Context)

Word translation will define the basic framework to build a simple word translation for IMED based on a 2000 words of medical terms. This approach to language (automata) is based on how babies communicate using nouns and one word modifiers. Routing or visit count should create a stochastic machine which leverages history and meaning to all expression. Leveraging past history in seconds facilitates an intelligent learning context for information acquisition. It will become clear that the ability to leverage decades in past history could define a standard in intelligent communications since it is hard to imagine the ability to explore past history transparently without leveraging this technology.

The IMED current framework supports a collaborative and interactive language communications facilitated by using a mouse as an input device. The interactive language strategy is 100% implement able in the current deployment configuration by creating a language base of about 10,000 components and English words which are mapped by several hundred descriptors.

The suite of IMED expert systems will have a natural automata capability excelling at the ability to learn and enhance the language as well has technological improvements. Specifically the ability to interact in a human like look and feel in an expert venue is based on leveraging decades of history in seconds complemented with collaborative language capability.

It is uncommon to see natural language capability leveraged in a search domain that is virtually intractable. Using the selection of component and component modifiers (symptoms) we should have a very attainable language strategy since the system identifies close symptoms applicable to the designated body component. After proper configuration and machine learning, there should be very robust conversations between patients and IMED robots.
“Expert shell can pilot most search applications including language-comprehension.
Expert System Expert Problem Solver capabilities are based on a finite basis set, provide comprehensive problem resolution space.

An Expert system is fundamentally built on its past history and the ability to leverage past history to make future decisions in seconds. Below we show several system views which depict an ability to locate a state as a collection of entities and define its past history using a visit count to the subject state. The concept of defining a collection or basis set provides for the system to articulate all of the germane requirements of a system. Conversation is implicit by the systems' ability to access a pattern in seconds or leverage a patterns past history in seconds facilitating use of past history to make decisions.

Why Should IMED answer many Medical Question

IMED architecture is built like a self healing network which may create an analog for interactive speech. My notion of conversation or speech is based on a global pie where the participants are filling in missing pieces. Specifically the states for homeostasis of each system and the entire body are known. All symptoms or error are sets of questions where the set complement can easily be defined therefore the missing parts of the puzzle or pie can be reconstructed. I believe that fundamental language conversation is based on a similar concept of whole set, part of the set collaboration and interaction. If this model in conjunction with routing or visit count is scalable the language feature could be one of the top collaborate module for all of the expert systems. Intelligent human like conversation has been lacking from our bout with machines. Interactive intelligent machines on demand could drastically affect the way we do business in all spectrums of society and international interactions.

Leveraging Past history in Seconds
Provide architecture capable of leveraging decades or even centuries of medical data in seconds.
Determine scalable strategy to identify body symptoms by leveraging past medical history
Determine scalable strategy to identify body diagnosis by leveraging past medical history
Determine scalable strategy to identify treatment plan by leveraging past medical history.
Provide Critical Care and Emergency environments with expert system response and the ability to leverage past medical history in seconds.
Provide definition of Intelligent Agents which will assist in a Critical Care Emergency Environment

IMED demonstrated the design of four distinct but integrated products; the Electronic Medical Data Record, Medical Diagnostic System and Intelligent Past history search engine, Expert System Shell which leverages a collection of software robots. Electronic Data Record provides for immediate access of all relevant medical data from an individual to facilitate routine and emergency access to medical records. The medical diagnostic system leverages over 1200 body components and 500 symptoms to facilitate a strategy to route to the appropriate medical authority and provide advice as to the severity of medical conditions. Herein Intelligent Agent technology is provided to leverage decades of medical records in seconds which include sensitive drugs and treatment alternatives. Expert System Shell technology can be immediately applied to dozens of other decision support application which require the access of decades of data in seconds to facilitate decision making. We successfully demonstrated leveraging decades of history in seconds which can be adapted to a number of decision support applications. We intend to mainstream a very viable technology in health care diagnostics and patient medical electronic data records which is positioned to be an international servicing model. Since the business model can be rendered on PDA and mobile computers, over the phone and internet, international mobilization should be quick and transparent.

International Medical Expert Diagnosis remembers all symptom strings reusing prior diagnosis information for current diagnosis and treatment strategies Medical process applications will be configured to trigger emergency procedures by recognizing certain critical symptom patterns. The technology can remember pattern space affording a feedback mechanism for critical patients monitoring and treatment advisement.

Commitment to Offering Health Care Advisory Services (Target 50 million Americans without health Care & 1.3 billion internationally)

Discriminating Technology
Leveraging decades of medical history in seconds and scalable games architecture
Capable of Critical Care diagnostic and assessment
Expert Diagnostic health services implementing expert system shell with software robots
Affordability of health care services (family plan)
International Web Site (business model) multi-lingual Health Care Service Access.
Doctor routing and patient collaboration (International forum) highly recommended
Routing of human services and outreach facilities
Maintenance and Mainstreaming of Electronic Medical Data Record

Primary the objective of Health care medical delivery services is to provide affordable access for large population over the phone, internet and other telecommunications interfaces. Many diagnostic system don't appear to provide a robust strategy for capturing patients conditions primarily because medical past history is not part of the computational model. Our target system can literally leverage several decades of medical condition for current diagnosis, affording a much more effective view into the patients overall health condition.

The Medical Diagnostics system should quickly evolve to support critical care diagnostic and treatment plan strategies. The Agent technology will learn a variety of scheduling, diagnostic, treatment and procedure orientated task. The end game of leveraging decades of past history in seconds involves software robot services and mobilization.

Critical Care Expert System

The path function (medical history) will help to establish past history which will ultimately be used to determine the next critical move. The system path is a by product of being able to leverage decades of past history in seconds.

### PATENTS FIGURES AND DRAWING

FIG. 01 Electronic Medical Record and Diagnosis Advisory implements pattern matching strategy which is striking similar to dialing a caller on the telephone system. IMED on the phone is designed to search 2 billion numerical electronic medical records for the corresponding treatment plan for current body systems. This performance is realized in a frequency driven architecture as electromagnetic wave travel/pattern match or resonates at the speed of light at matching frequency diminished by medium and bandwidth.

FIG. 02 International Medical Expert Diagnosis defines an interface for routing patients to the appropriate doctor who will provide appropriate services based on the submission of electronic medical records available on the phone system or some internet storage strategy. The body system will be the primary routing strategy (e.g. respiratory, nervous, muscle etc.)

FIG. 03 Pattern Match Answers and questions Model of a Human body depicting all knowledge of body component and Homeostasis. This model shows all questions derived from information forming a basis (complete set that spans a vector space) are capable of being answered by leveraging past history in seconds in this context. The model illustrates a complete set or pie where all information locations have defined knowledge. This bit string could represent a basis vector set. All information removed or lost can be represented by the set complement thereby defining a heuristic to keep track of missing information in a frequency bases system.

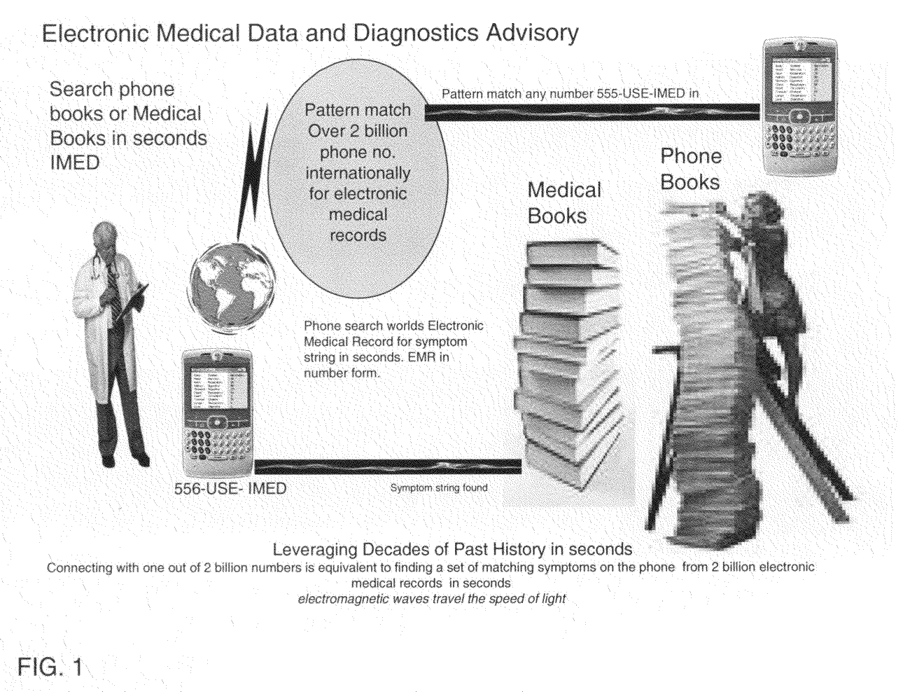

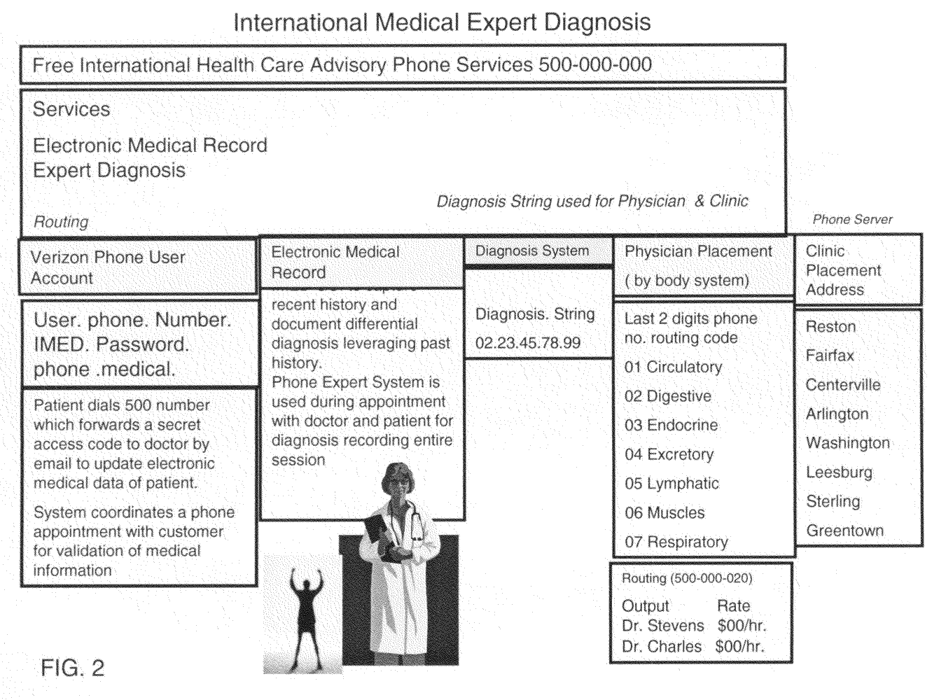

Optimal Software Robot Design is based on search, pattern match or resonance and very large storage capability. A collection of bits can represent any set of objects being available for processing or not. We leverage this architecture for software robots and expert systems. We assume a system with all of the data or a string of ones (111111111111). The system uses powerful pattern matching or piece removal to find various information requirements or answer any questions addressed to the system. This architecture could represent the strategy of a self-healing network since at the start condition all information is accounted for (a set of ones) therefore going back to homeostasis is updating the (0)s to (1)s leveraging past history in seconds.

FIG. 04 International Phone Access of Medical Services interface provides a customer internet access to services from the phone system. At this interface enrollment for a variety of phone service is conveniently available.

FIG. 05 Remote Health Care Access for 50 million People (nationally and potentially ˜1.3 billion people internationally) shows flow chart for PDA s' outlines a workflow for a typical phone session on the IMED Medical Expert System. This step by step process gives customers an overview on how collaboration is achieved on the system. The objective is to provide a phone and internet base system which will be available internationally to provide convenient affordable health care on the phone and other telecommunications' conduits.

FIG. 06 Health Care Software Robot specializing in Diagnostic Advisory facilitating a powerful strategy for diagnosis referral leveraging potentially Billions of electronic medical records world wide over the phone system from international physicians' treatment plans. The system collects all system and forms a numerical diagnostic string which facilitates a frequency driven search over the phone or internet. Pattern matching resonate a large search domain of numerical electronic medical data until the corresponding treatment plan is found that matches the electronic medical record search string.

FIG. 07 Traffic Congestion Controller Robot a providing telephone keypad input of traffic roots (program maps roots to number ultimately building a number string which can used to quickly pattern map congested route plans with the intent of provide a close to real-time update capability. Traffic Congestion Model illustrates a database model of the traffic conditions which can be accessed by a cell phone.

FIG. 08 Gene Medical History Utility provides and interface for identifying gene related disease and providing a group of people who suffer from the same illness. Gene History provides the ability to leverage related cases and occurrence of the condition over a number of decades leveraging this information in seconds.

FIG. 09 General System Problem Expert Solver or IMED Robot Universal depicts the superset or template of a genre of software robots. The technology herein is capable of embodying all of the target software robots. The key strategies of Software Robot deployment involves leveraging past history in seconds, the piano keyboard storage design capable of capturing centuries of system transients in a very small footprint and designing the appropriate basis set of vectors that span the problem space.

FIG. 10 Electronic Medical Record with Diagnostic Advisor System Analysis Agent identifies major human body systems and captures commensurate system maladies. The intent of this module is to provide a forum for troubleshooting specific body system based on past history of each patient. Exploiting process of elimination is one of the tools of analyzing and determining aberrant medical conditions.

FIG. 11 The Scheduling Agent is depicted as the expert system GUI in scheduling mode providing the ability to make appointments with health care professionals and plan follow-up encounters.

FIG. 12 IMED illnesses Pattern Match Rife frequency scanner (reference a) or MRI and other frequency based technology could be used with IMED to document the frequency ranges of a variety of body components in order to establish a base line to be used to detect illness patterns. We consider the body as a frequency spectrum which needs calibration upon the onset of illness and ultimately leverage a treatment strategy based on the body frequency roadmap. MRI and a variety of frequency driven technology has help map by systems and component to identify aberrant conditions in the human body.

FIG. 13 Sequence Diagram Frequency Signatures Workflow of Rife frequency scanner which is depicted in the FIG as a process strategy that can be used in conjunction with IMED for physicians to integrate drug, traditional treatment and frequency techniques based on availability of resources, cost and medical experience. Fundamentally right column outlines strategy for constructing a frequency roadmap for the individual which map will the appropriate frequencies based on Dr. Rife research. This technique should facilitate phone or internet treatment strategies.

FIG. 14 Global Wellness plus Micro Current Frequency Generator reference sketch of a micro current frequency generator capable of scanning for aberrant frequency signatures in the body and providing a treatment strategy. IMED technology can be coupled with the aforementioned frequency based treatment since corresponding knowledge base information can leverage decades of patient history.

FIG. 15 Depicts phone like search when leveraging past history in Seconds-work follow of pattern matching in a phone system applicable to leveraging potentially billions of numerical (frequency based) electronic medical records to facilitate finding a matching electronic medical data record with the appropriate treatment plan (Previously diagnosed condition).

FIG. 16 Electronic Medical Record—the blood tests will provide some of the most definitive feedback for human homeostasis. The list of blood parameters provides an illustration of how blood-features will be an integral part to monitoring patient conditions using the IMED GUI symptoms' interface. In general reading actual test values could be primarily based on meeting high low criteria within specific ranges.

FIG. 17 Diagnosis Analysis Alternatives provides an excellent tool facilitating differential diagnosis and review what if scenarios very quickly leveraging actual patient or general population electronic medical records.

FIG. 18 Piano Data Storage Model data captures system history using a finite footprint of 88 piano keys and their corresponding visit count. Since a piano is a collection of frequencies, we leverage this paradigm as a means of writing to the appropriate frequencies as we store data. This strategy maximizes reuse and minimizes storing the same data in various sections of the storage medium. This method should be a vast improvement in performance and storage space. Specifically storing system data in a finite set of frequencies with corresponding visit count will greatly increase storage capacity. You can play hundreds of million of song in an 88 key range since visit count and time and date always a data retrieval strategy.

FIG. 19 IMED Electronic Medical Record is a convenient and accessible way of capturing the medical history of a patent and making this information accessible on phones or over the internet in seconds. The objectives of the electronic medical record are to facilitate easy access to provide a patient of the best treatment scenarios.

FIG. 20 International Medical Expert Diagnosis illustrates a handheld device which is capable of interacting with the IMED Expert System network. These devices are geared to bridge the digital divide based on convenience, low cost and accessibility.

FIG. 21 Dr. Rife Frequency Resonance Locates and Destroys Viruses. There are over 500 bacteria, viruses and protozoa which have been identified for frequency treatment based on Dr. Rifes' research. The IMED Graphical user interface provides and analytical framework to store and retrieve patient history information within seconds.

FIG. 22 Searching through entire world Electronic Medical Record in seconds using pattern matching has been achieved in the IMED expert shell environment. The process is akin to placing a phone call or identifying medical symptom patterns from an international database in seconds providing a very cutting edge approach to analyzing information.

FIG. 23 Routing from the Diagnostic Profile is a Sequence Diagram depicting treatments and drug prescription design patterns and data information flow. This illustration shows that if you consider a bit string representing a set of objects in homeostasis, then the set complement tracks the errors or aberrations in the system been treated providing a platform to document medical history.

FIG. 24 Software Robot component process briefly outlines some of the capability of the IMED technology. Software robots identify task roles which are designed to leverage past history in seconds as a means of identifying user requirements.

FIG. 25 Critical care Advisory System identifies a type of Software robot which primarily operates in monitoring mode processing input patient data real-time as well as medical history to facilitate a treatment plan based on prior similar medical incidents

FIG. 26 Language Comprehension is a key module of IMED General System problems solver which captures the work flow of an automaton. An automaton is a start state, end state, set of symbols, set of transitions and set of rules. Specifically the ability to leverage past history is key to facilitate a powerful search of all relevant past history then, the ability to store all past history are the key proponents of supporting conversational language.

FIG. 27 Software Robots depicts the data flow by showing data requirements, expert shell, piece removal and pattern matching requirements and finally the set complement paradigm which facilitates intelligent questioning. Self healing network in this context is viewed as a string of bits representing different objects which are either one or zero values on the string. The repair the network requires an operation which restores all zero bits back to one.

FIG. 28 Sequence Diagram Patient Doctor Collaboration data flow of a collaborative session for a patient and doctor using available phone, expert system and telemedicine technology.

FIG. 29 Search Agent Expert System Applications summary of candidate applications for software robot and expert system which will leverage a key algorithm of leveraging decades of past history in seconds to achieve real-time decisions and next move objectives. The Expert System Shell facilitates using data from libraries of basis vectors leveraging very large search domains and access in seconds to facilitate a variety of conventional and critical care response times.

FIG. 30 Software Robot Data Structure summary of the bit string data structure and pattern removal heuristic with reference to Chess search space. Piece removal is the key strategy to extinguish chess enormous pattern space and provides one of the most powerful pattern removal or search technology strategy for storing and retrieval of objects constrained in a very large space.

FIG. 31 Software Robot Data Chess Algorithm Software Robot Data Structure brief combinatorial summary of a pattern space and using piece removal to reduce patterns and search complexity Chess Algorithm. The Chess search paradigm was a major motivation for defining the architecture of IMED which facilitates finding a set of constraints out of an intractable number of patterns. We find this search propensity in chess primarily because piece removal extinguishes thousand of trillion of patterns ultimately trapping the king by a process of elimination.

FIG. 32 Electronic Medical Data graphical approaches appear to be key strategies to illness and process analysis. Facilitated by leveraging decades of history, it is possible to reconstruct many illness patterns and design cure strategies based an in-depth understanding of the behavior graph.

FIG. 33 Medical History provides a search graph approach for storing electronic medical data leveraging the ability to actually trace a disease path down each collection path. Each collection (001) has a unique path or route facilitating the ability to uncover processes and sequence of events based on collection of strings.

FIG. 34 Software Robot Data structure Diagnostic is a layout for designing a heuristic for analyzing the human body from a search and frequency perspective. A complete development of this graph should help to vastly improve how illness conditions are documented and treated. Robust approaches to curing illness could start with a calculus which captures systems processes, behavior and the ability to leverage medical history for a real time view of the system.

FIG. 35 Software Robot Data Medical Data Structure Chess search model is an interface for patent which should capture many of the necessary body behaviors from a frequency and search perspective. This illustration defuses much of the inherent complexity of intractable system by creating a classification scheme used in conjunction with the IMED software robot interface. Learning and routing from system transients can be captured in a finite foot print facilitating very fast retrieval. Herein lays the topology and real-time decision making power of the software robot technology. See FIG. 6-12.

FIG. 36 Software Robot Data Structure Graph illustrates output from a program written is C, thirty two systems which could represent collection of symptom strings. Here in the processing path for a string (10111110111111111111) which can be derived to better ascertain system behavior based on the ability to leverage medical history in seconds.

FIG. 37 Model for illness and Disease Evolution outlines a Boolean control system. The Boolean architecture is probably the most sophisticated technical construct that we have. Its powerful attributes provides the basis for stealth search, storage and simple modification.

FIG. 38 Strategy for Reusing Past Games a Boolean lattice or linked list leveraging a strategy to reused collection is a very powerful scalable model. Key aspect of reuse is search efficiency and a great reduction in system storage space.

FIG. 39 Weight Distribution is used to facilitate deciding how objects are routed on a game board. In the game of chess each piece has a value which may be represented by a number. This determines the importance of this piece as the game strategy persists.

FIG. 40 Depicts the analog of Robot Brain with Memory—the Boolean lattice is a key data structure construct in trying to simulate intelligent behavior. The search algorithm leveraging past history in seconds is the essence of establishing intelligent behavior.

FIG. 41 Differential Diagnosis and Next Move Analysis is a crucial medical service involving the ability to diagnosis conditions and define the appropriate treatment plans. Using process of elimination underscores a differential diagnosis strategy. Next appropriate move or action relies on the ability to leverage what is known about past history quickly to direct efforts to decide on the correct course of action.

FIG. 42 Optimal Game of Capture Strategies illustrates the lattice of captures states form a set of optimal path as game pieces are removed from the board. This architecture can be used to construct a number of optimal path heuristics leveraging piece removal toward a goal state in addition it depicts the fundamental architecture of International Medical Expert Diagnosis (IMED).

FIG. 43 Search depicted by a spread sheet high lighting selected body components. These components can represent a collection which has symptoms. The collection locates an address in space as the diagnosis string. We have an N dimensional typology map whose discrete collection represents diagnosis collections.

FIG. 44 Intelligent Traffic Control System is one of IMED software robots capable of approximating a real-time tracking system for traffic conditions along city routes. Herein the ability to leverage traffic congestion history is instrumental in understanding the behavior of the traffic system. This model is based on decades of information on a frequency grid which is updated and accessible by phone access. The phone is basic calibrated to read the state of the frequency sensor which represents various roads through the city.

FIG. 45 International Medical Expert Diagnosis Base Services summarizes descriptions of the capabilities of the software robot technology. This brief listing of services is just a few of the potential many derivable capabilities of these software robots. Hundreds of actors with their commensurate list of behaviors can be created with the ability to store behavior information and leverage past history in seconds. IMEDs operating system provides a very expansive list of capabilities providing the end-user with predefined and definable robot activities. The system is capability of assimilating decades of learned behaviors and the ability to leverage decades of past history that trumps several life times.

FIG. 46 Intelligent and Multi-Agent Implementation Strategy summarizes descriptions and implementation strategy of multi-agent systems. This description of Multi-Agent capability was obtained from research on the Internet and does not represent patentable materials. Software robots and intelligent agents in this context can leverage cooperative business strategies, make decisions, recall large about of pattern matched information based on past history and establish language, automata and other communications protocols.

FIG. 47 Interface GUI for IMED Illness Pattern Match (Rife Frequency Map Body Component & Frequency Patterns) Dr. Randle Rife in the early 1960s devised a methodology of killing harmful, bacteria, virus, protozoa and some cancer strains by using frequency treatments (treating a variety of 600+ different viruses and bacterial using a potentially safe strategy of treatment). The GUI integration of frequency, drug and traditional treatment methods is being patented here a process flow design for determining viable treatment strategies for medical systems.

FIG. 48 IMED Expert System shell provides the framework to store and retrieve list of words which can be leveraged over decades of history and association in seconds (historical context). Secondly, the technology allows the storage of thousand of terabytes of information (piano storage strategy). The fundamental architectural issues provide the basis to support conversational languages.

FIG. 49 Blue Print for International Job Provider and customer bidding is a process strategy which will send out a number of requests originated by patients for a scope of medical services. A number of requests and responses from a group of doctors will be exchanged with estimates for the needed work based on electronic medical record and current symptoms

FIG. 50 Phone routing based on ICD-9 Routing Codes comprising of a phone strategy which is numerically based which is used to complement IMED numerical electronic medical format to facilitate fast access and convenience for processing medical conditions.

FIG. 51 Data Model Pattern Match Search comprising of a methodology to design and implement software robot specifications and requirements by leveraging database modeling tools to design frequency sensitive tables which will store information for dozens of telephone software robots.

FIG. 52 Electronic Medical Data Software Robots consist of a comprehensive list of requirements which include a comprehensive list of body components, body symptoms, electronic medical records and sundry treatment plans

FIG. 53 Animation and Simulation of Collaborative Humans leverages pattern matching technology over a predefined associations of database table which facilitate a strategy to provide an animated characters which could include stored procedures to facilitate object movement and navigation.

FIG. 54 Large Reusable Memory Capacity for PDA is comprised of process which can vastly increase the state space of a software robot or agent driven technology. The piano algorithm leverages a finite set of key where is it possible to play millions of song modified by using a key counter to track the number of times a piano key was played. Applying a finite set of key with a mechanism for record system visit count provide strategy to increase accessible state of a system tremendously.

FIG. 55 International Medical Expert Diagnosis will provide maintenance and monitoring in critical care environment since the system is capability of monitoring thousands of conditions and learning system behaviors and processes. Using Pattern matching and a strong storage strategy will provide a robots and time sensitive way to monitor an number of patients in need of critical care.

FIG. 56 Bit String Model of Human Body Showing Systems illustrations provides an overview of the IMED strategic approach to symptom diagnosis by assuming a homeostasis condition which must be recalibrated through treatment consistent with symptoms that the system uncovers.

FIG. 57 Sensitivity Analysis of Epidemic Model describes a catastrophe that could develop if the proper protocols are not in place. The IMED platform provides a network able to determining symptom diagnostics which could augment international approaches to dealing with pandemic crisis.

FIG. 58 Optimized Intelligent Search Process summaries and intelligent Search describes the benefits that this architecture provide in efficiency and information storage. IMED Search provides a collection of rules, conditions and search protocols like games piece removal and the piano storage algorithm which results in process model for optimal search strategy.

FIG. 59 Doctor Patient Collaboration International Cell Phone provides for an international language forum for communication with cultures of different languages. Specifically IMED technology provides a cell phone interface to translated languages using a numeric common denominator. The process leverages languages strings in seconds providing a historic interpretation of the meaning of word phrases by example.

FIG. 60 Electronic Medical Data Doctor Routing this form show how information is provides so the appropriate doctor can be contacted and mobilized for remote patient care. The electronic medical data provides the necessary background to facilitated a proper treatment strategy.

FIG. 61 References

A. http://www.rifehealth.com/
B http://www.frontiernet.net/˜breightondawe/fifeail.pdf
C. Global Wellness Plus

Software Robot Capabilities
Scheduling Agent schedules phone or email collaboration between doctor and patient for review of symptom-diagnosis and electronic medical Data.
Symptom Agent collects symptoms from diagnostic engine and doctor interview documenting results in medical expert system
Diagnosis Agent assembles past medical history from electronic medical data and incorporates current symptom conditions
Treatment Agent select a treatment plan based on past medical history and current treatment options
Drug Agent reviews drug history and prescribes medication alternatives for current medical condition.
Contact Agent provides a list of medical doctors and health care professions which may serve in a conciliatory role for newly diagnosed condition
Research Agent provides a search engine to further analyze current diagnosis and treatment plan for diseased condition
Monitoring Agent captures feedback from handheld or other waveform generated by an external monitoring device.
Game Agent and Critical Process Agent provides a games and procedure optimized architecture for capturing critical care processes and procedures
Medical Process and Procedures Agent capable of storing and enumerating thousands of medical procedures based on a string of symptom conditions.
Agent decision-making architectures and their evaluation, including deliberative, practical reasoning, reactive/behavioral, plan-based, and hybrid architectures.
Cooperation and teamwork, including organizational structuring and design for multi-agent systems, self-organization, emergent functionality and swarm intelligence.
Multi-agent planning and planning for multi-agent systems, and the coordination of multi-agent plans and activities.
Computational auction systems, computational market systems, algorithmic/automated mechanism design, automated negotiation, and computational social choice theory.
Knowledge representation and reasoning for, and logical foundations of, autonomous agents and multi-agent systems.
Agent programming languages—their implementation, semantics, and evaluation.
Distributed constraint processing and distributed constraint optimization.
Multi-agent argumentation and dialogue, conflict detection and resolution.
Multi-agent learning, co-learning, and evolutionary approaches in multi-agent systems.
Agent communication languages, their semantics, pragmatics, and implementation, and agent communication protocols and conversations.
Conventions, commitments, norms, obligations, and social laws in multi-agent systems, and models of trust and reputation.
Believable and synthetic agents and characters, and human-agent interaction.
Environments, test-beds, and programming languages for experimentation with, and analysis of, agent systems.
Ontology for agent systems, agents and the semantic web, agents and semantic web services, Grid-based systems, and service-oriented computing.
Robotic agents and multi-robot systems.
Agents as a software engineering paradigm, including agent system development, specification and verification of agent systems, methodologies for autonomous agents and multi-agent systems, analysis and design for multi-agent systems, evaluations of different approaches to developing agent systems, and significant practical experiences with agent system.
Exploration of relationships between agents and other disciplines such as psychology, linguistics, philosophy, and human-computer interaction; and the relationship between multi-agent systems and other disciplines such as economics/game theory, sociology, and organization theory.

Software Robots

The ability to record history and leverage past history in seconds is the minimum but sufficient capabilities of a software robot/expert system. The ultimate mandate of an information based society is to provide information expedience. Job development will be enhanced since it will mobilize people in the highest form of collaboration. The system-diagnosis procedure may turn out to be prolific and software technology shaping process. As we take a collection of symptom leveraging a diagnosis by pattern search, this resembles a string comprehension process. A collection of numbers (representing symptom-diagnosis) is leveraged for pattern search (diagnosis). This is analogous to using an input number string facilitating pattern matching decades of similar patterns forming a past history input-response space. Phones, will be able to recognize speech request and actually search a very large knowledge base in seconds for scenarios which serve as possible responses. The response collection is an analog for treatment plans.

The Collaboration Technology Turing Machine

Technology seems to be going in the direction of integrating systems and people for the purpose of increased productivity. The Optimized Intelligent Suite of applications integrates some very basic aspects of optimized communications and endeavors to provide products that are extremely user-friendly to the end-user. The phone and many other PDA are internationally recognizable and provides an interface that is very common place and intuitive. The architecture of OIS should provide expert-system and software robot capability to answer the question the customer asks. It appears that the cutting edge technology which allows users to engage decades of past history in second is also the technology for man-machine intelligent exchange of requests. Note the conversation will be based on the technologies ability to process any string and retrieve information spanning decades. Clearly in a medical venue these features will be prominent, empowering people all over the world to be engaged by a medical expert system capable of asking the right questions to ascertain a medical condition.

The term Turing is an attempt to outline the basis vectors which spans medical cognizant devices and software assemblies. Ultimately a set of Medical design patterns will further facilitate reusable modules for building Medical software. Unparallel search, leveraging past history and processing power will launch PDAs to serve as an answer forum and a remote sensor and update medical strategy.

PDA facilitates the fundamental health care delivery issue which involves access to service. The current implementation of this expert system technology is available to participant who has a PDA or cellular phone access.

### PRIOR ART

### THE OBJECTS AND ADVANTAGES OF THE INVENTION

Traditional Medical Diagnostic systems take user input in the form of a collection of symptoms in an effort to speculate a probable cause or diagnosis. The subject Optimized intelligent Architecture leverages unparalleled search, past history and processing power to provide an improved reliability in predicting the progression of human illness. Homeostasis is defined in terms of metrics which define good health. There are two hundred body parts including blood, urine and vital signs which are incorporated in the diagnostic strategy.

Specifically we are analyzing a business object which will be offered as an internet service internationally. The key aspect of this analysis is simplicity and scalability of medical services offerings to a multi-lingual international community. The target platform is the Business phone which serves as an internet services conduit to a number of diversified markets. PDA requirements are that it can read a web page and support configuration to support a menu system of 200 human components complementing a diagnostic system. Each of the 200 human body components are either pristine or in symptom state. A Medical Diagnostic system of good caliber is ubiquitous especially one that leverages past medical history of patient for present diagnosis in a few seconds. An Expert System caliber shell device on a PDA is also ubiquitous since it accommodates a number of different expert system applications on the same interface.

The pattern search strategy appears to be many times more powerful than most if not all of the convention search strategies that are currently mainstreamed. Low priced expert systems of this caliber will also make it affordable and easily incorporated in a number of different languages and collaboration settings. Artificial Intelligence is underscored by search (intelligent) and search engine technology will probably dominate many computer driven initiatives, hence the search technology leveraged in this endeavor will be the commodity which redefines the foregoing expert system implementation.

There are a variety of data flow processes drawing which outline how information is passed through each phase of the process. Some of the drawings actually depict the as built system illustrating the GUI interface.

Health Care Clinic Mobilization of Medical PDA

Target a Health Care Clinic to be used as a prototype network of Medical Expert Diagnostic Systems. Ultimately national clinics should form a hub or a centralized agency for coordinating health care services leveraging health care PDAs. At a minimum these sites will provide PDA diagnostic and low cost feedback instruments devices to the population without health care and assume a medical history documenting role. They will assist in uploading to an agency database and individuals PDA medical security chest. These agencies will facilitate the mainstreaming of the electronic medical database requirements.

Health Care Clinic Services
Medical Record Keeping and Validation
Maintenance of Electronic Data Information
Scheduling (in person phone and system assisted)
Treatment Monitoring
Symptom Diagnosis, Support, Counseling
Patient exam and physician referral

Medical Expert Diagnosis System Services Via Personal Data Assistance (PDA)

Primary goal is to document patient medical history, pictures of incidents, measure and record vital signs, direct patient to best fit medical facility based on condition and income.

Secondary goal support state of the art medical diagnostic search engine which will diagnose based on characteristics like ethnicity, age, location etc.
(Patients) PDA
mobility
Documenting Medical History
Scheduling patient collaboration with health care professions
Symptom Diagnosis
Early Detection services
Leverage Past history and Present symptoms
Collaborative Diagnosis
Referral System nationally and internationally
Future (interactive voice natural language dialog)
Patient & Healthcare collaboration
(Doctors Interface)
Symptom Diagnosis and Analysis
Group tutorial with anonymity
Email patient symptom photographs ideally maintained in health clinics
Accumulate Groups of like Symptom Compute Confidence Intervals
Symptom Convergence due to number of Cases
Doctor update of patient record
Doctor formulate treatment plan
Expert System Learn by feedback auto-clustering and classification engine
Design early financial incentives for doctors to contribute to an international effort to collaborate about health care problems.
Specially design Medical Workstations with added security and specialized search capability

Reasons for Using Online Medical Diagnosis

Nevertheless, in some instances, such online services can be useful to people. Some examples of such reasons may include:

Expense: Medical consultations can be expensive and alternative methods of interacting with medical experts can be useful.

Embarrassment: Some people may find it easier to discuss the details of embarrassing physical medical conditions, or to discuss their own personal issues in counseling, when doing so online.

Convenience: The practical difficulty of traveling to the doctor's office can be an issue for some.

Time: Some patient's feel that they do not get enough time with their doctors, and may have numerous questions left unanswered after a consultation. Although these points are reasonable, nevertheless, this decision needs to be weighed against the fact that it is likely that the quality of advice provided over the internet will be significantly lower than would occur in a face-to-face consultation at your doctor's office.

Personal Option Although I am not knowledgeable about health care analysis and initiatives. Common sense leads me down a path assuming that problem solving is crucial by maintaining excellent medical history and leveraging as much history as possible to reconstruct a problem. I suspect thousand of lives are compromised on the operating table as well as due to tragic accidents primarily because proper history was not available for the patient. Your medical history is probably the single most important factor in how you behave as a person and your propensity for medical conditions along with genetics.

A hand held medical device affords an opportunity for frequent visits and a more on off the scene on the scene approach to resolving medical incidents immediately.

Data (Basis Vectors)

The user of the expert system must define a collection of basis objects which span the problem space. It is assumed that a linear combination of any set of these basis objects will correspond with any instantiation in the domain. A light weight version of basis vectors is programming variables. Typical collection of basis vectors for Expert Systems Medical, Trouble Shooting, Enterprise Resource, Chess, and Genome are derived by experts or system professionals.

Expert Shell

Reusable container in the expert system (minus the basis vectors) which facilitates the search for the correct set of states which identify a set of aberrant conditions or in the case of symptoms a medical diagnosis. The actual data structure resembles a link list with an added capability of performing the set complement. An expert system answers the questions the customer asks.

Piece Removal

Facilitates Search Problem by removing objects from game tree (e.g. capture in chess game or pattern reduction strategy. It appears that piece reduction in a games venue is one of the unparalleled search strategy mainstreamed.

Set Complement

The set complement determines all missing data from the target set or basis set of objects. It is a set operation which keeps track of missing information and object location. In performing diagnosis or system analysis on a system we assume the initial state of homeostasis defines a well working collection of components. As system inconsistencies and flaws arise, the diagnosis process keeps track of all the original start states of the system, collects all the system aberrations or symptoms and identifies the set of objects which needs to be restored to make the system complete. The forte of the diagnosis process is the ability of keeping track of trillions of trillion of system states leveraging a search process that is fundamentally derived from the chess piece capture process.

Expert System Problem Solver

In general, if you know all the information missing from the system you have total information about a system. A more complete postulation of total information of a system involves leveraging the past history of a system which is assumed to be part of the missing information. The concept of Homeostasis Analysis involves a start state or collection of unit vectors that span a domain space. In time the system may loose information or its configuration may be altered.

Identifying the missing information and restoring this information provides total system information. We hope to generalize this observation to read when total information of a system can be established we may be able to formulate a process which may restore missing information to specific identified locations.

The “Expert System Problem Solver” identifies a strategy to determine the missing information in a system for the purpose of restoring it to its original state (levering past history and using set complement process (tracks location of objects)). This may not be trivial; in fact it may be quite arduous to determine the missing components of a system. The primary way of identifying missing components is to have a feedback system which may ask system related questions or maintain a sensor type feedback strategy to alert the system stakeholder that something is missing.

It is the goal or approach in the “homeostasis approach or Expert System Problem Solver to provide a defined initial state of total information. As system transients progress, the system will loose information at which point IMED or a Expert System Solver will identify the missing information by feedback and then restore the specific locations of missing data.

Nano Technology promises to be a very effective way of obtaining feedback from the human body ranging from strategies of analyzing blood to infiltrating areas of the nervous system that are unwonted to current day technology

Phone Interface for Medical and Expert Services

Leveraging numbers just like on our phone system, electronic Medical data and Medical Diagnostic system should be able to go through thousands of pages in seconds to find a medical condition and related information. This will empower physicians to search for strings in the system (eg. Medical data) in seconds accommodating critical operating environments or servicing office visits. When you dial a phone number you are walking down a graph eliminating well over a billion numbers in seconds. If no holes are encountered in the demo, this technology will be very aggressive compared with the top search engine and the phone strategy for search,

The most pervasive and possibly the most dominant paradigm for offering Remote medical and other expert system services should be launch using the phone system. Using directory assistance as an analog, the system has the capacity for (thousands of cities or) body parts and symptoms. The search strategy would be very powerful identifying doctors for a given specialty by using the phone number in routing mode. [city.state.country.specialty.xxx] vs. [7.8.4.66.7.5.]

Since speech activation is already recognizable in directory assistance, it can be configured for speech interactivity for body part, symptoms . . . medical record info. Phones are available everywhere therefore use as a monitoring tool would be second nature. Many reporting features are already available over the phone making electronic data and diagnostic report relative easy to configure on first glance.

The International Medical Expert Diagnosis has an innovation with respect to the graphical interface. There are two sides to the first column (field) which shows Body components and the other side showing Agents. Specifically, the first database field list close to 2000 body component where symptoms are mapped to the appropriate component. The Agent field, which is activated by a toggle button, list about 40 agents which includes scheduling, monitoring and diagnosis tracing in addition to about 10 body system which behavior patterns are recorded in order to leverage past behavior history. Illness analysis can be done by leveraging past history and pattern discovery on the body component level or the body system pattern history. Test and procedure patterns can be generated from the Agent and symptom interface.

Each of the over 2000 agents learn behavior and creates a path function which serves as a history where information can be extracted in seconds.

Deployment of Electronic Data Record by Web and Phone

An implementation of Electronic Medical Data by phone from a cursory perspective looks very attractive. There are cost, security, user efficiency issues in the balance but clearly phones are much more accessible and in national use than any other telecommunications commodity. In principle electronic medical data may be offered as a service with add ons for additional configurable features. Herein a licensing fee may be attached to using various technologies. The up side is that mainstreaming services internationally could be relatively seem less after security and a sundry list of incidentals. As proposed before software robot technology would have an excellent launching platform after proper mobilization of medical requirements and health care tool implementation.

Dominance in the phone paradigm will depend on marketing and securing the most attractive medical features in various technical venues. Note the web side implementation has still not been dominated by a Health Care giant.

Base Case of Reasoning is based on its ability to develop prioritized cases or “diagnosis” leveraging lessons learned from past history.

The Turing test and other anomalies try to capture how machine intelligence can be described and be deployed but so far has been somewhat illusive. I think part of this contemplation is the ability to leverage past events effortlessly to facilitate immediate decision making. Equally important is to instantiate a data structure which excels at differential diagnosis or the ability to use process of elimination and testing to further refine the best path for further analysis.

Traditional AI uses methodologies like forward chaining, backward chaining, Horne clauses, inference engines and production systems to feign the process of elimination efforts in advanced systems decision. Pattern Recognition may be the dark horse in using past history to supply actual examples of the appropriate responses to questions and, in a general sense, what are the appropriate moves on a game tree based on pre-defined rules.

The prior discussion on reasoning was based on the need to explore the current architecture for the ability to support AI functionality and decision making. Optimistically, with adequate requirements gathering, the Agent-Software Robot will automate many mundane tasks and sophisticated processes providing more time for model building and building more robust designs. It is clear to me that the sophistication of our technology provides a direct impact on our international competitiveness and the ability to maintain market share in key areas.

The next big technological revolution will take place on the phone system—PDA, not as profound in the mobile computer domain. Specifically we use the phone in voice mode and software robot and expert system technology is poised to be launched most efficiently on the phone. To underscore what is being brought to the table is a powerful search technology-leveraging decades (centuries) of history in seconds, differential diagnosis (process of elimination) and treatment leveraged by pattern discovery. I view these commodities as the base architecture for software robots on a phone system.

Our entire culture of how we interact with information would dramatically change and the level of productivity and process control. Think of the effect of spreadsheets, databases, and other office automation technology since they made otherwise obscure information paradigm Intelligible. Artificial intelligence introduces a new level of clarity and empowers us to do what would be otherwise impossible under traditional means. Pattern recognition with efficient search is the key problem solving strategy in this venue.

The “Anatomy of the Software Telephone Robots” is shown in the attached figures and detailed in a clear concise way. Systems (IMED) are a suite of software robots which will have expertise in a variety of decision support areas. Ultimately these entities will be collaborative and interactive exchanging information between various phone nodes, as a strategy to satisfy requests. It is not implausible to realize substantial gains in efficiency based on intelligent technology. When properly implemented this design could provide a new venue to foster international trade of information in addition to creating a much more intelligent interface technology to bridge many technological barriers we currently face. In a linear as opposed to an intractable economy, technology should always provide an edge and avenue to a health economy.

Traffic Congestion Robot (Brains or Task Manager Robot)

Autonomous-Self Directed
Command Driven

The Traffic or congestion control robot will process thousands of tasks and traffic patterns leveraging past history of these processes in seconds. It will learn daily routes and strategies and manage the vast quantities of information processing requirements noting completion time for these task as a way of optimizing or choosing the most efficient alternatives.

The IMED telephone software robot provides an interactive and collaborative capability based on a frequency response and evaluation (pattern matching) heuristic and the ability to store an enormous quantity of past history on a PDA device. This architecture defines the intelligent disposition of a large number of information processing paradigms which require critical response and real-time deliverable and services on PDA and other telecommunication interfaces

Self Driven Software Robots are problem solvers who identify system aberrations and pursue solution strategies to correct the problems. Consider tens of thousands of tasks being processed, prioritized and optimized to fulfill a set of business initiatives. One of the key components of addressing task processing is the notion of routing and priorities and the ability to learn new policies as information is updated in the system. The ability to leverage decades of the equivalent of electronic information in seconds provides a real-time evaluation of incidents that is probably unparalleled in information processing.

| Search Agent Expert System & Decision Support | Leverage Past History in Seconds |
|---|---|
| SOFTWARE: Categories | 40 Applications Expert & Decision Systems |
| 01. Real-Time (Embedded) | Self Healing Networks |
| 02. Control Systems | Vulnerability Analysis |
| 03. Operating Systems (OS & IOS) | Engineering Control Systems |
| 04. Protocols | Engineering and Applied Sciences* |
| 05. Legacy″ Networked Applications | Process and Data Modeling |
| 06. Unprecedented″ Networked Applications | Chemical Controls Systems |
| 07. Sensor-Based | Mechanical Controls Systems |
| 08. Location-Based | Electrical Controls Systems |
| 09. Grid-Based | Expert Systems |
| 10. Swarm-Based | Decision Support System |
| 11. Known″ Non-Networked Applications | Business Models (data flow, optimization) |
| Summary of IPV6 Search Engines | Financial Models (cash flow, break even) |
| Target IPV6 Intelligent Brokers Search Engines | Health Care (diagnosis, analysis, treatment) |
| Diagnostic agent | Defense and Tactical Systems IPV6 and OIS |
| Trouble shooting agent | exceptional |
| Treatment Plan agent | Security Initiatives (i.e. leveraging past history of |
| Medical Record-History agent | defense vehicles) |
| Medical Scenario and Games agent (Machine | Games |
| learning) | Recreation (children, adult) (prototyped evaluation |
| Medical Process and Operating Room Procedures | function)* |
| Agent | Educational (children, adult) |
| Business Control Systems | Simulation/Tactical/Strategic |
| Business Development Models* | Computer Animation |
| Finance Model | Mathematics and Applied Sciences |
| Loan Development Models (prototyped) | Fourier analysis |
| Enterprise Resource Planning | Set Theory and Deployment |
| Business Data Flow Models | Solution of Turing compliant Strings |
| Operating Systems | General System Problem Solver |
| Software Development | Non linear to Linear Transform |
| Integrated Development Environment | N dimensional Problem Solver |
| Advance Software Modeling and Deployment | Unprecedented Network Applications |
| Software (networks, operating system, application | Grid-Based-Navigation for Autonomous, Mobile |
| software) | Robots |
| Hardware (configuration, performance) | Swarm Based-Software Architecture for Radio- |
| Real-time (embedded) | Based Mobile Self-Organizing Systems |
| Trouble Shooting Systems (prototyped) | Sensor Based-network is designed to run on |
| Software Robotics | Bluetooth using the Serial Port Profile |
| Intelligent Agents | Location Based-software on the smart phone |

1. A method comprising of an Expert System shell primarily for search and process control applications as data is processed mapping text to numbers to facilitate leveraging decades of history from a large knowledgebase in seconds using pattern matching primarily for capturing system behavior for analysis as in the case of pattern matching a phone number over billions of other numbers as these queries on electronic knowledge collections or directed to health care professionals or routed to a health care software robot capable of processing search requests see independent claims 2, See FIG. 6-12

2. A method using the Expert Shell to deploy Intelligent Agents & Software Robots Applications for process control and application development leveraging past history in seconds using pattern matching and machine learning as a further mechanism of defining machine errors, routing and system characteristics as agents provide special functions to the system such as scheduling, monitoring, diagnosis and treatment recommendations as a search string is composed of a context and a set of behaviors and the composite set is pattern matched over a pre-existing frequency storage of past history of electronic records in seconds as past electronic history can be leveraged as a “frequency database storage” strategy as depicted in FIG. 6-12, 29

3. A method using PDA and other telecommunications interfaces to record medical symptom incidents for body components-symptoms in numeric form, to capture requirements maintaining numeric “electronic medical record” providing a mapping of body component and symptoms facilitating a numeric and multi-lingual storage strategy which could be leveraged on PDA, phones or telecommunications interface as body component (concept subject) and body system (context) followed by symptoms or collection of terms as this string of terms for diagnosis are pattern matched leveraging electromagnetic waves scanning a knowledgebase of potentially matching patterns and applicable treatment plans See FIG. 6-12

4. A method comprising of an autonomous or self driven software robot, problem solvers identifying system aberrations and pursuing solution strategies to correct the problems by using processes to return the system to a set of ones e.g. homeostasis, consider thousands of tasks being processed, prioritized and optimized to fulfill a set of business initiatives, as a key aspect of addressing task processing involves routing, priority setting and the ability to return the system to a state of homeostasis, this type of software robots would involve a processes to return to the state of homeostasis as a Self Directed Objective=G (111 . . . 111) where this configuration is the start and the end state execute processes returning to the original state.

5. A method using PDA and other telecommunications interfaces to record numeric medical symptom incidents for body components-symptoms to capture requirements maintaining “electronic medical record” providing an interface for medical diagnostics as a current collection of symptoms are collected in the form of numbers, with decades of numerical electronic medical history used to pattern match or leverage a process to locate medical history which can be associated with the current symptom set, revealing prior applicable treatment plans using pattern resonance or pattern search process as the acquisition heuristic. See FIG. 6, 7, 9, 12

6. A method facilitating capabilities of a PDA software robot for internalizing information, as IMED architecture selecting body components and symptoms mapped to numbers which will be used as pattern matched strings over decades of past history in a frequency domain, equivalent of electronic medical records, finding treatment plans from prior solutions, from a large frequency storage interface as general system problem solver software robot leverages a basis set of objects which span a vector space like 88 keys on a piano spanning traditional musical frequencies, formulating and concatenating objects forming frequency base signature which are pattern match with decades of historic patterns to identify solutions to outstanding problems, architecture support learning thousands of processes and procedures, interactive multi-lingual communications, expert shell support for dozens of decision and problem analysis applications. FIG. 16, 34, 35

7. A method to facilitate human body system diagnosis as a list of over a thousand body components represented by a thousand bit string model where (zeros) map the appropriate symptoms and (one) designate ok body components as a diagnosis string compose current symptoms in order to leverage the entire medical history by pattern matching new symptoms over a large phone or telecommunications knowledgebase as the phone architecture provides and international forum for potentially pattern matching a set of symptoms. See FIG. 6, 8, 10, 12

8. A method comprising an architecture facilitating deferential diagnosis process by pattern recognition and search for differential cases leveraging past history leveraging past history in seconds, as true differential diagnosis is facilitated by a systematic process of elimination and inspection of probable cases as the output of the diagnosis string, providing an ordered historical list of “electronic medical records” as the process induces an ordering of symptoms with respect to body component or another ordering parameter, first then by symptom type. See FIG. 6, 8, 10, 12

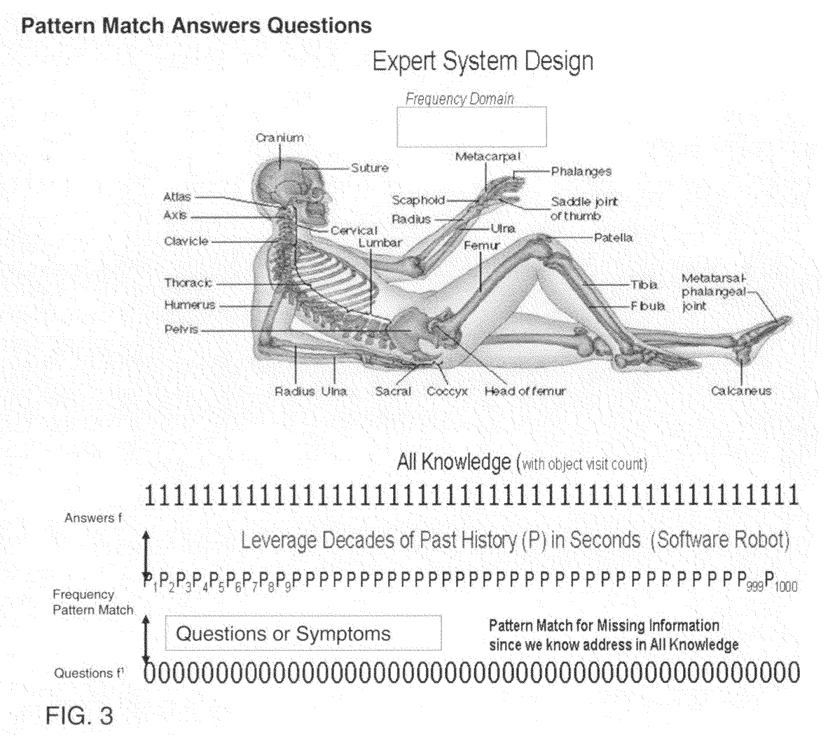

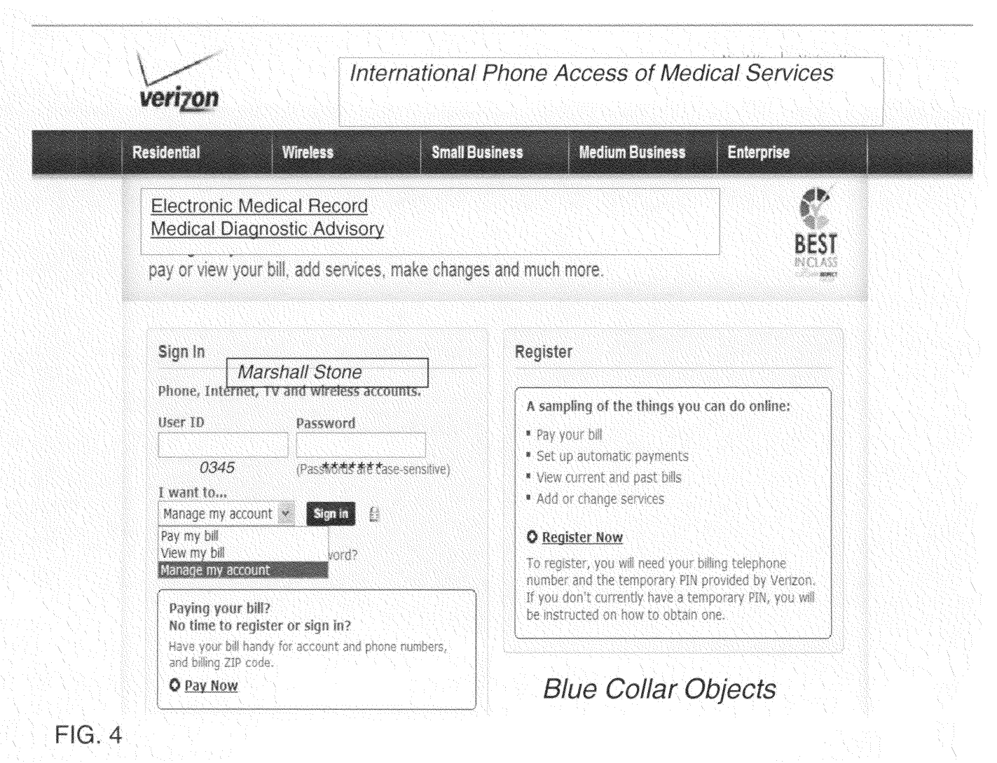

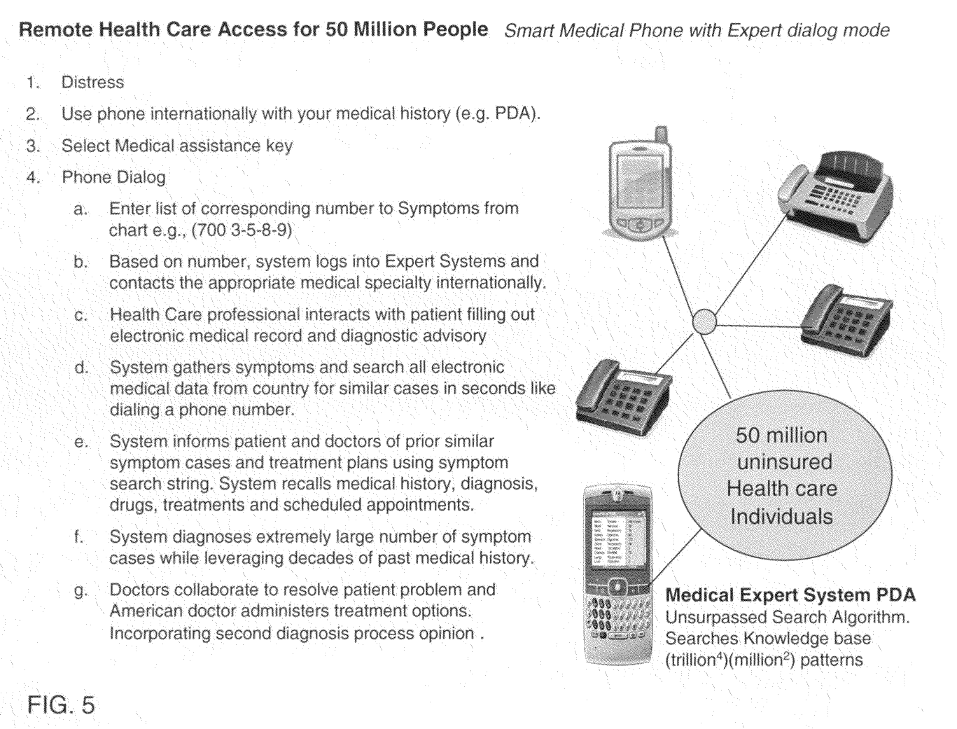

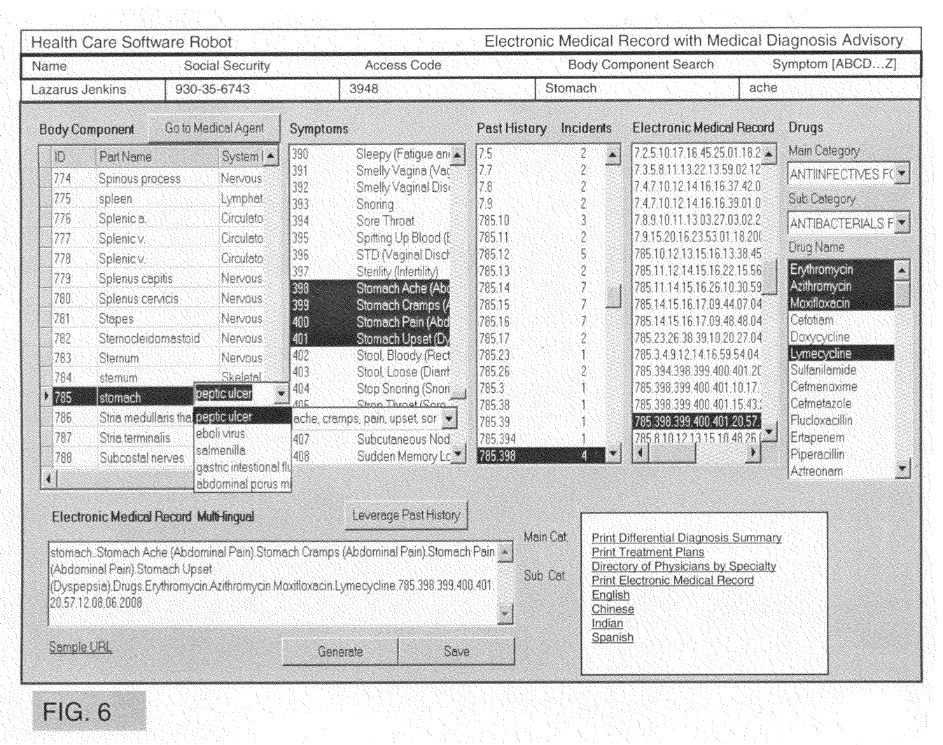

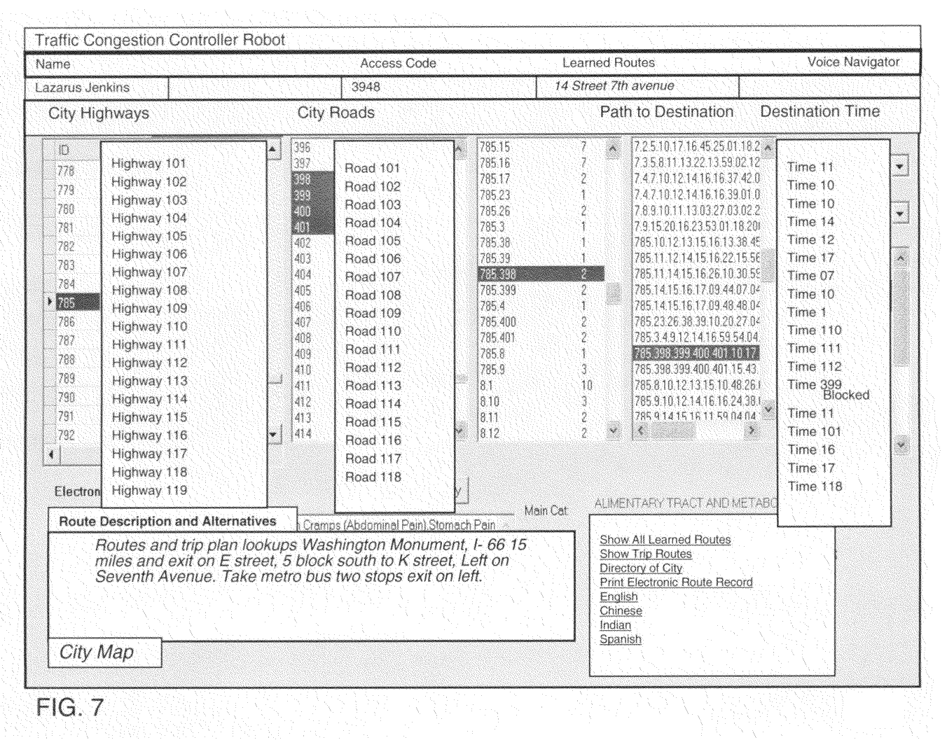

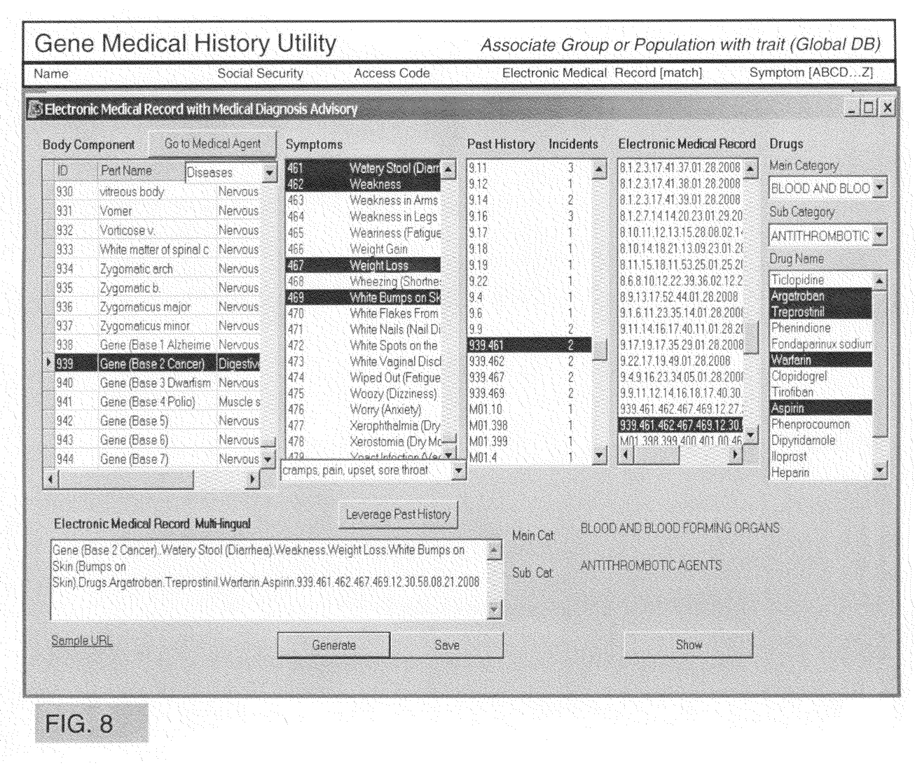

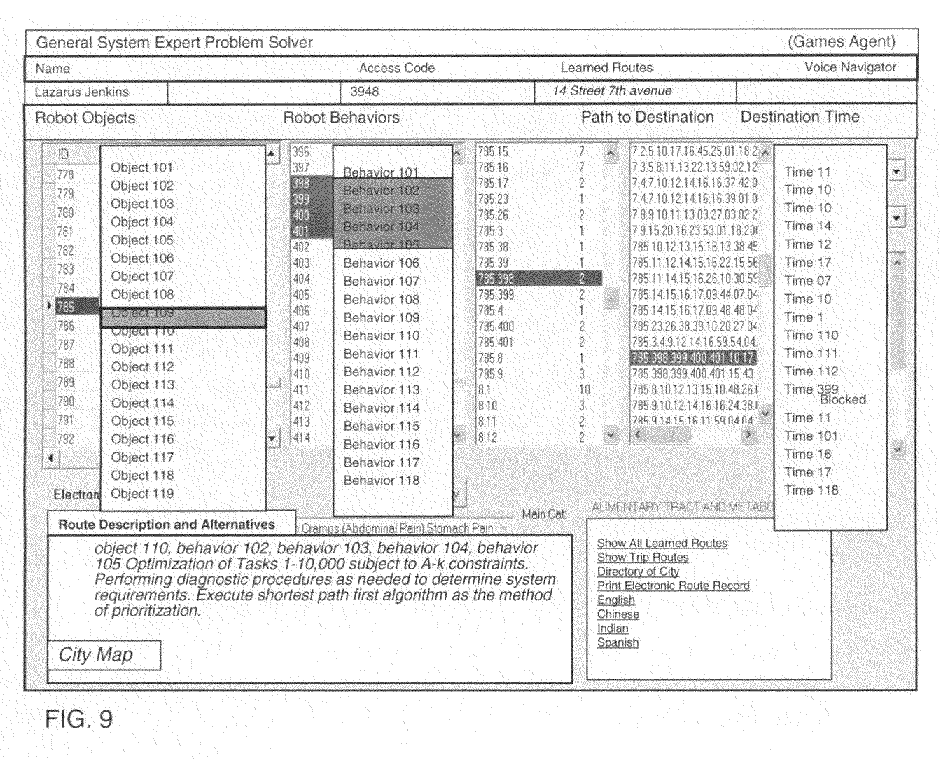

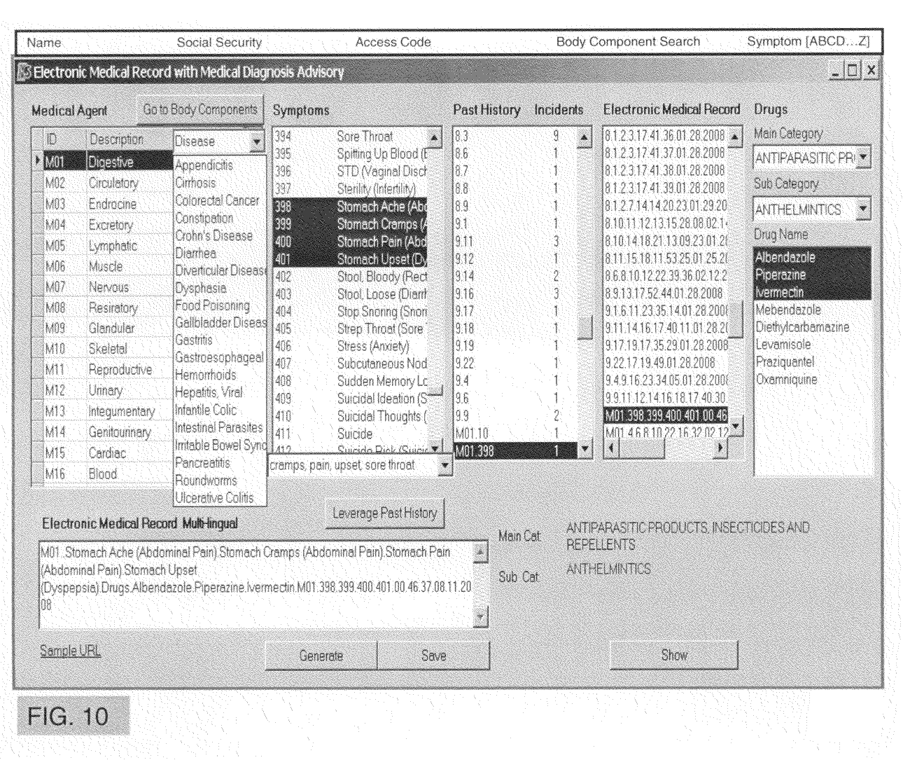

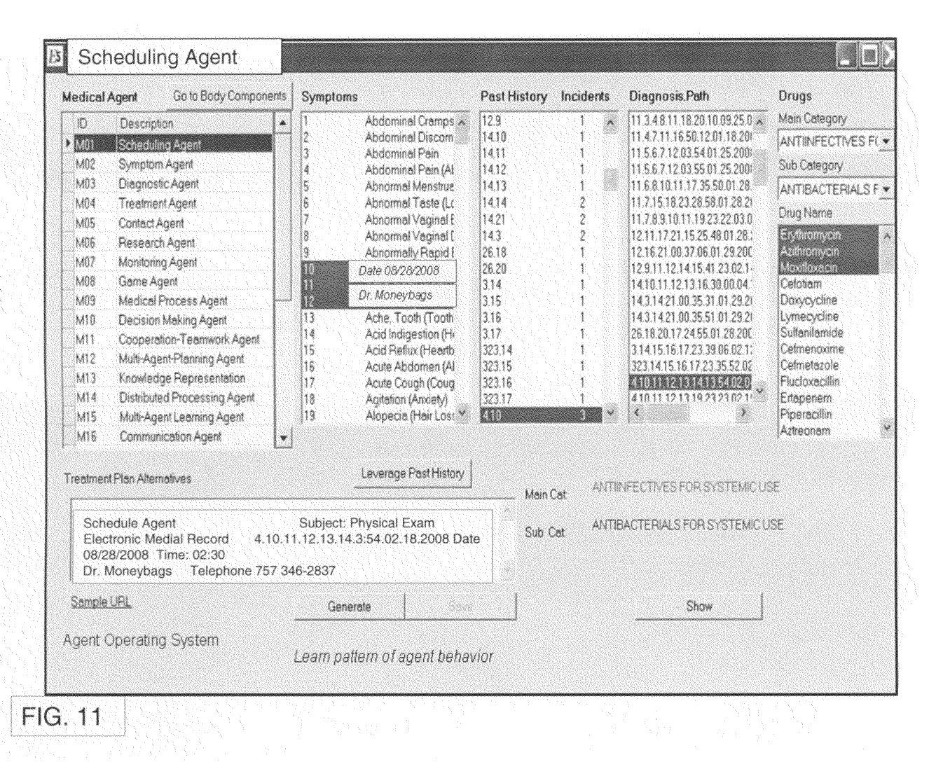

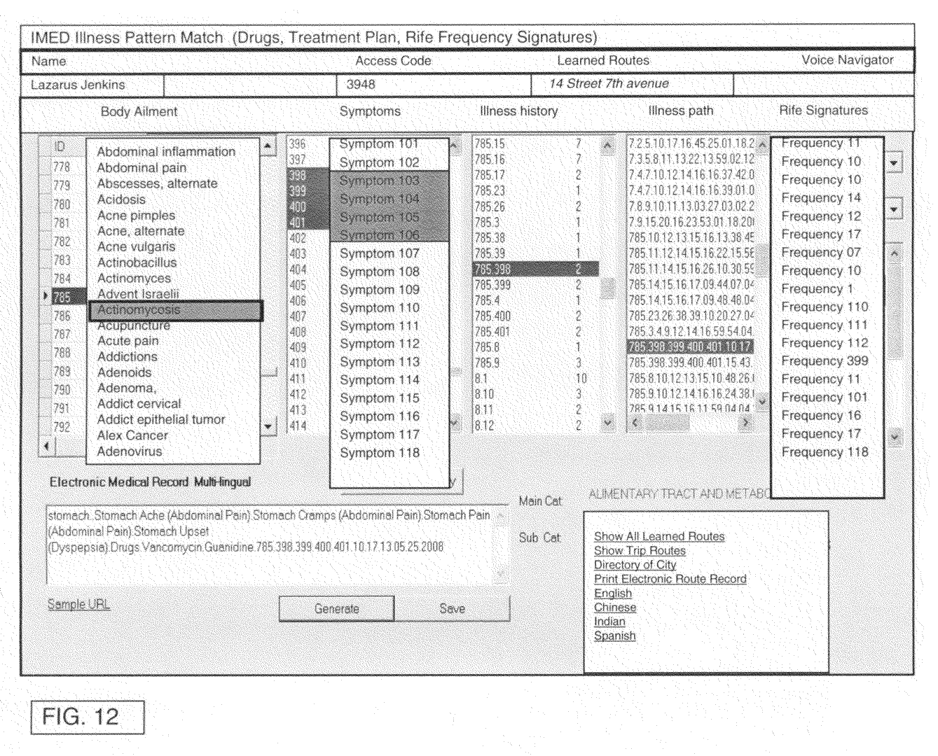

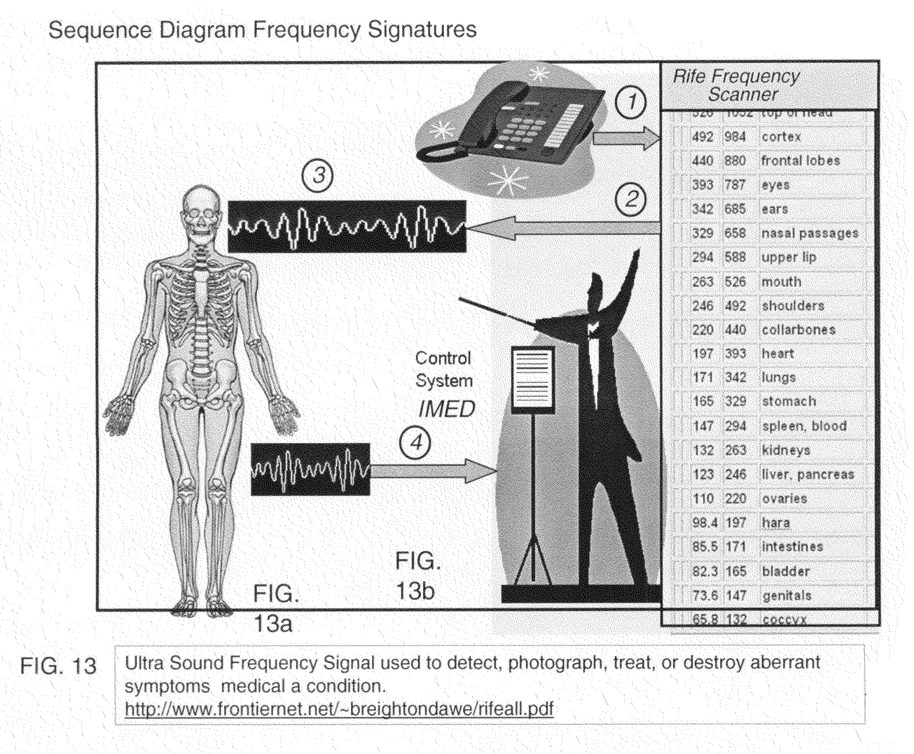

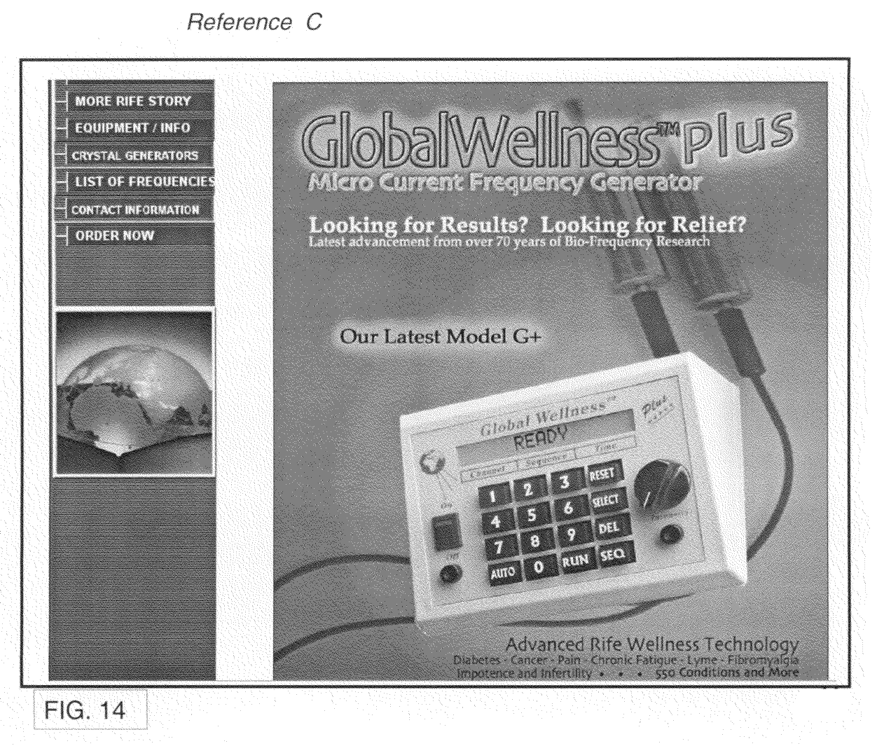

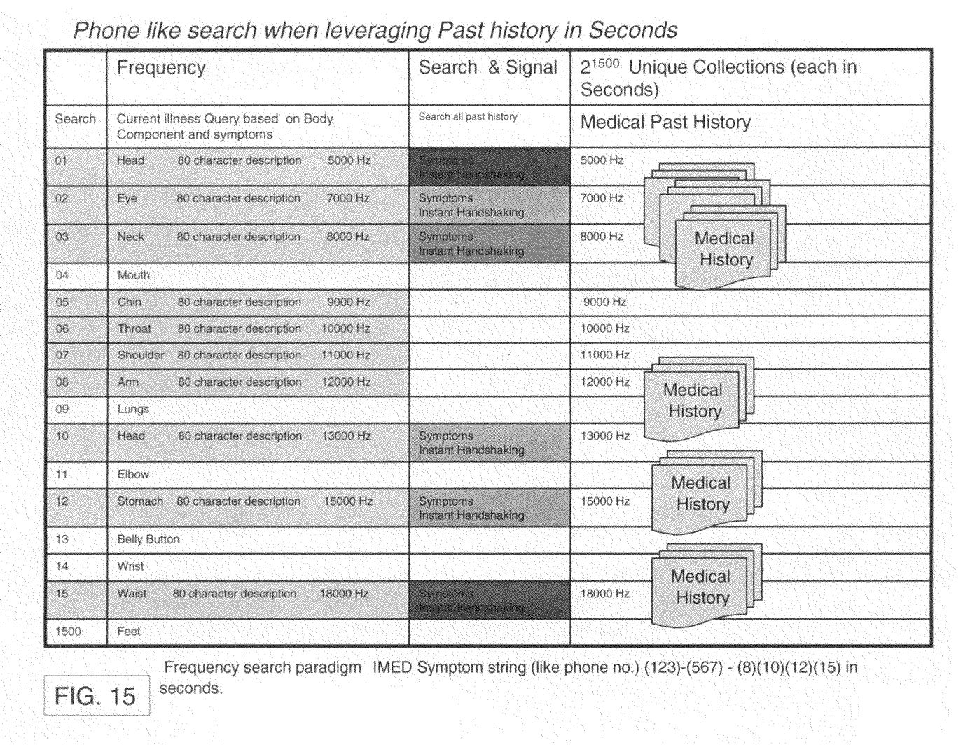

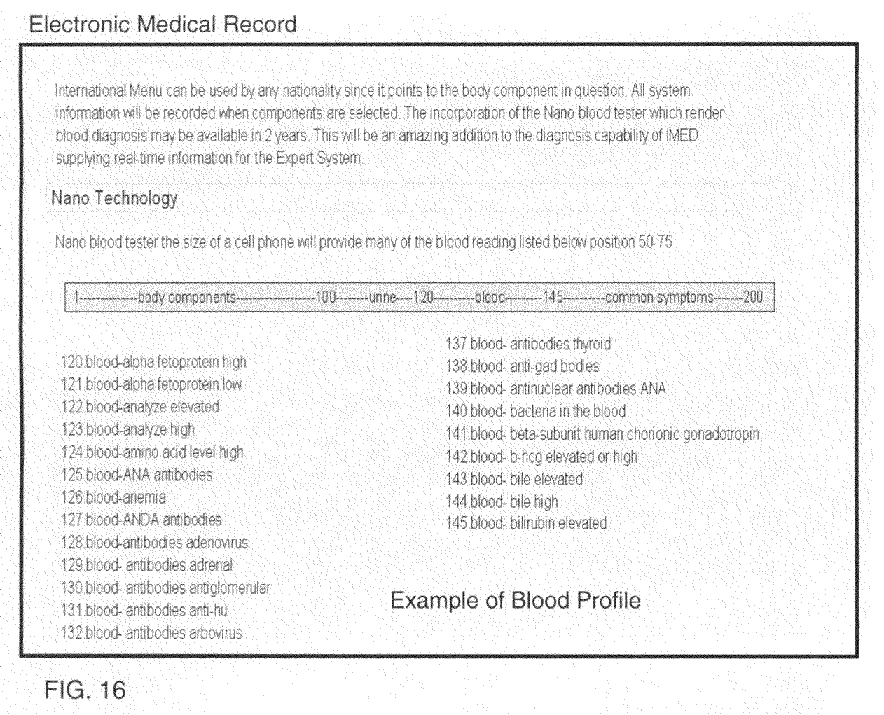

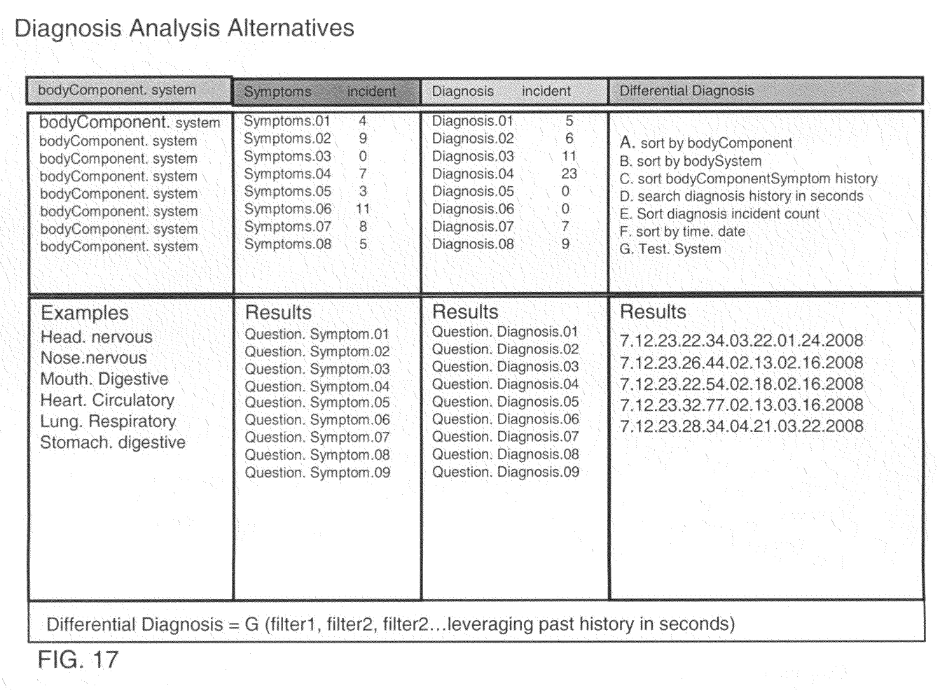

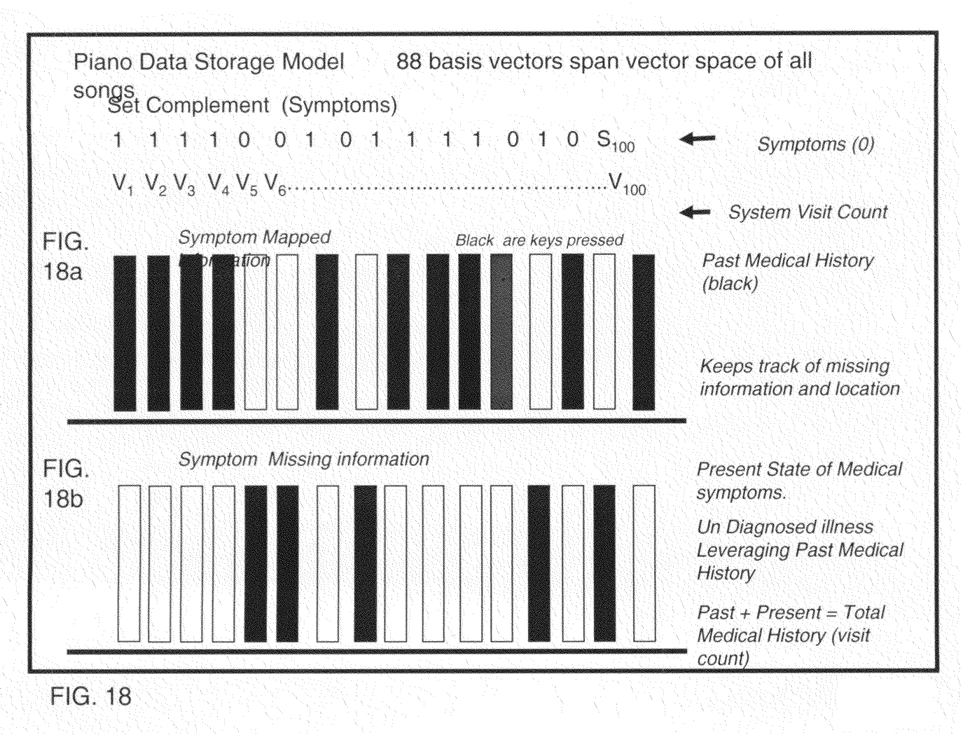

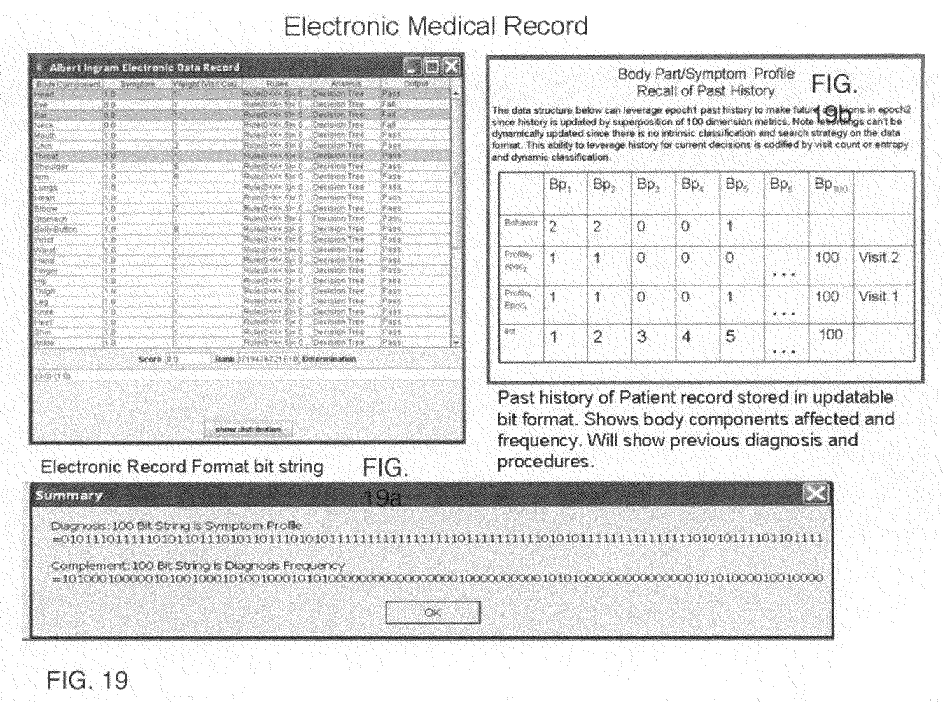

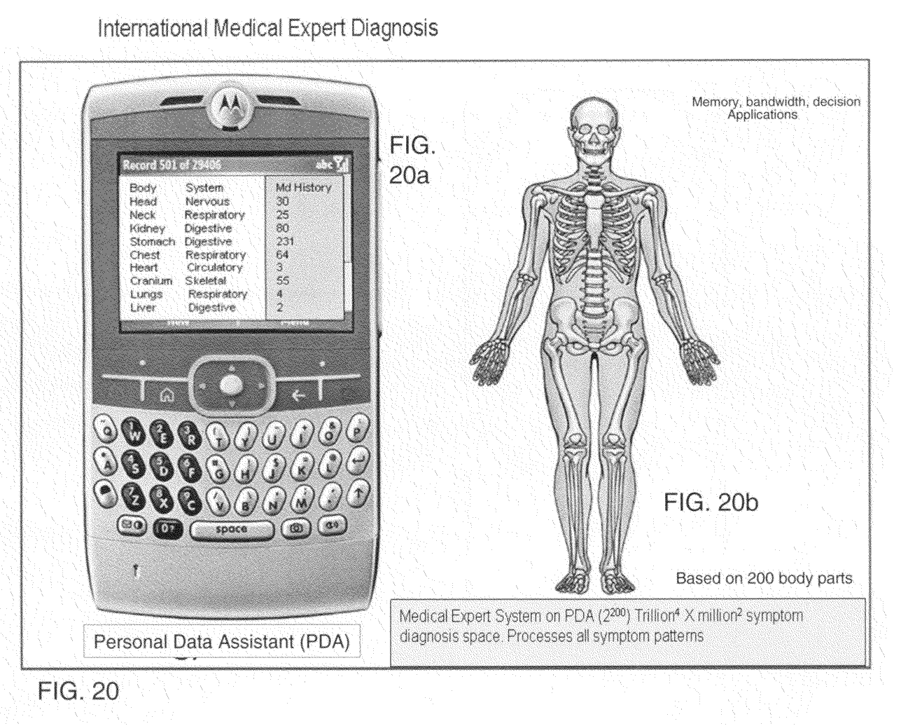

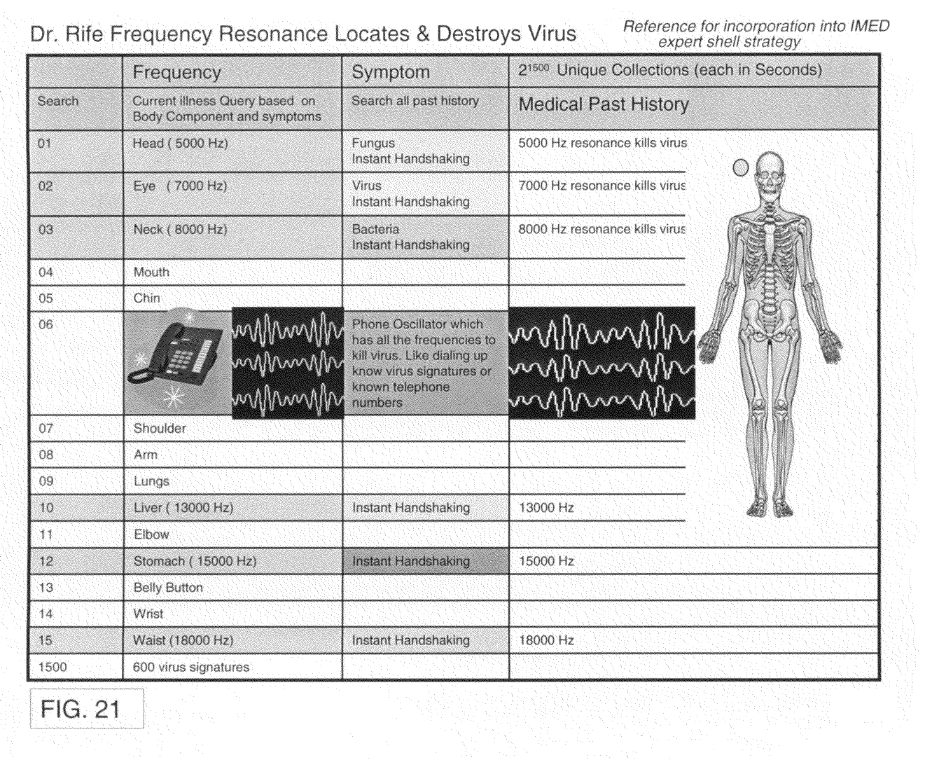

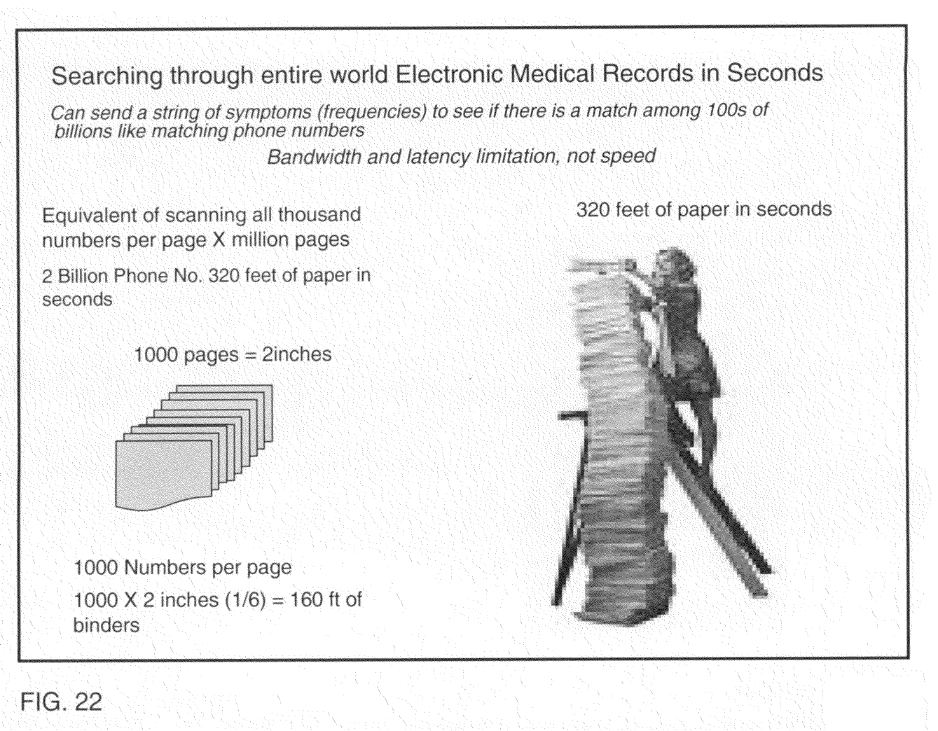

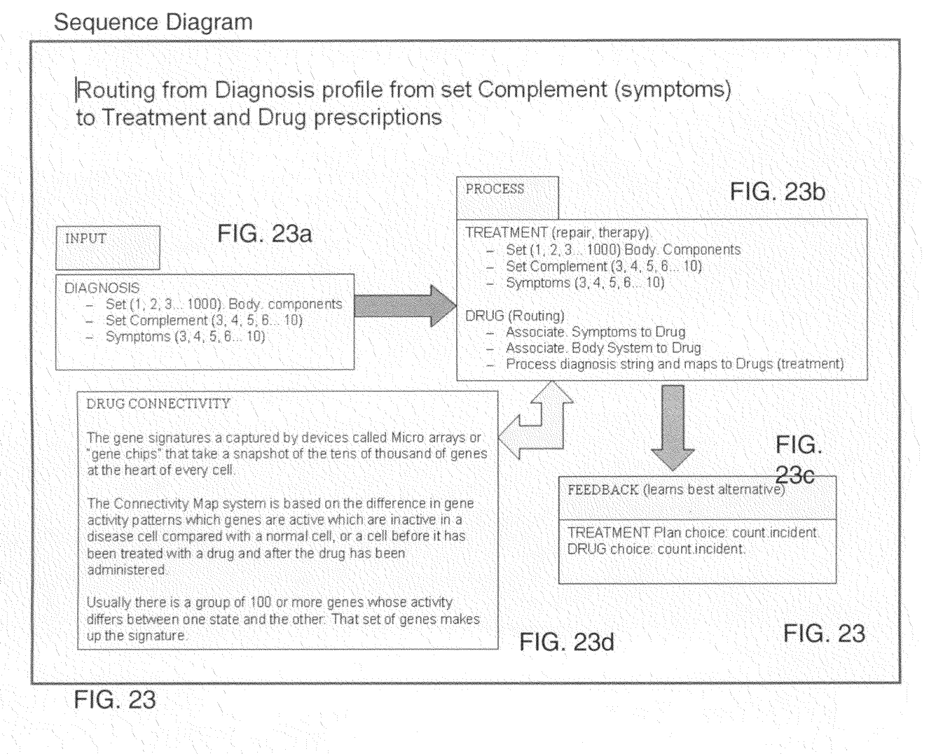

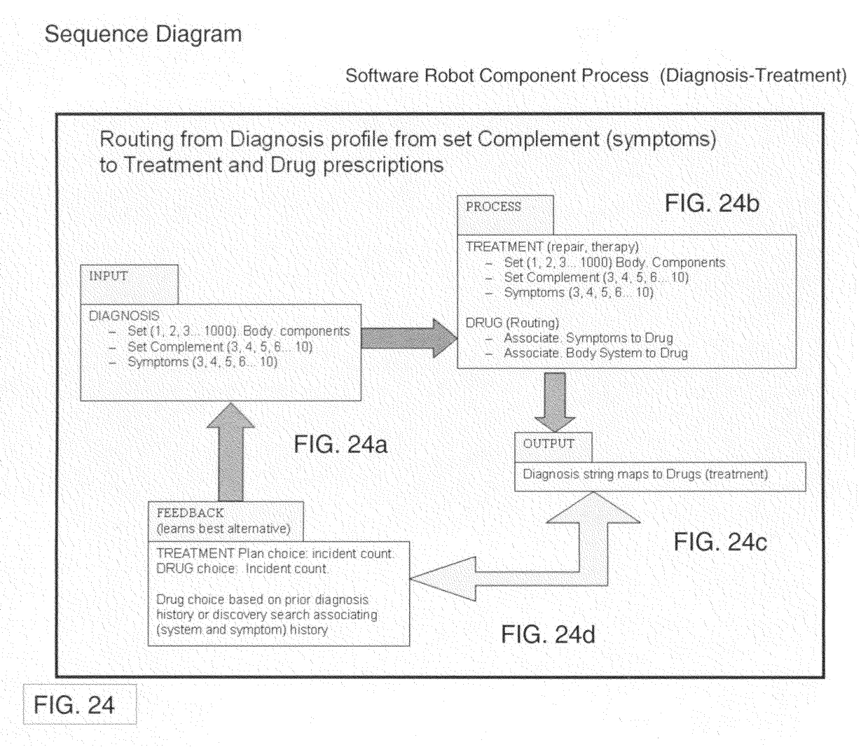

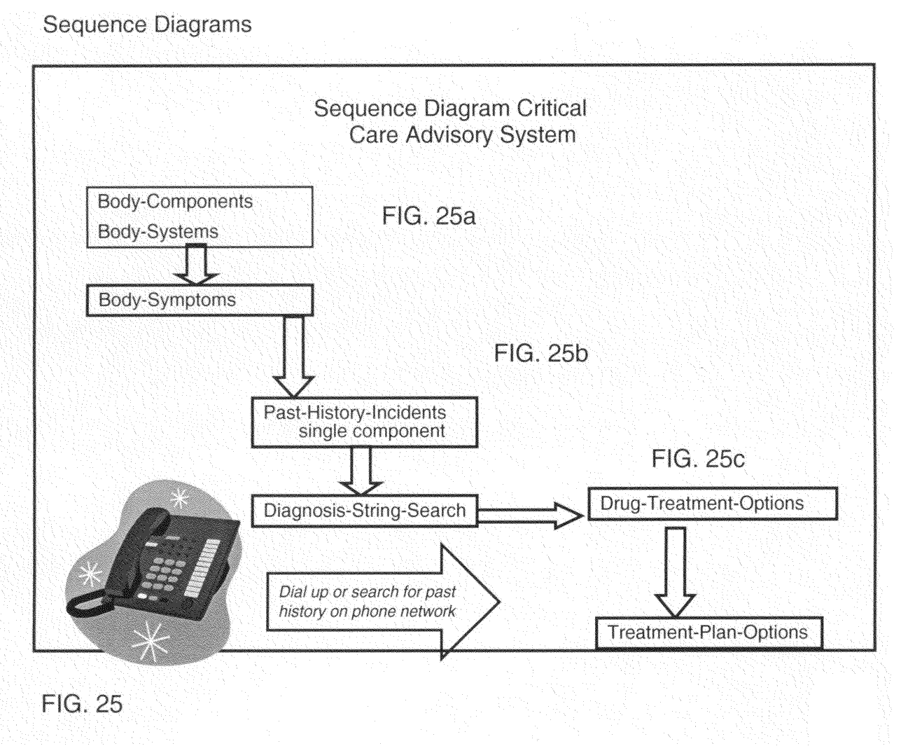

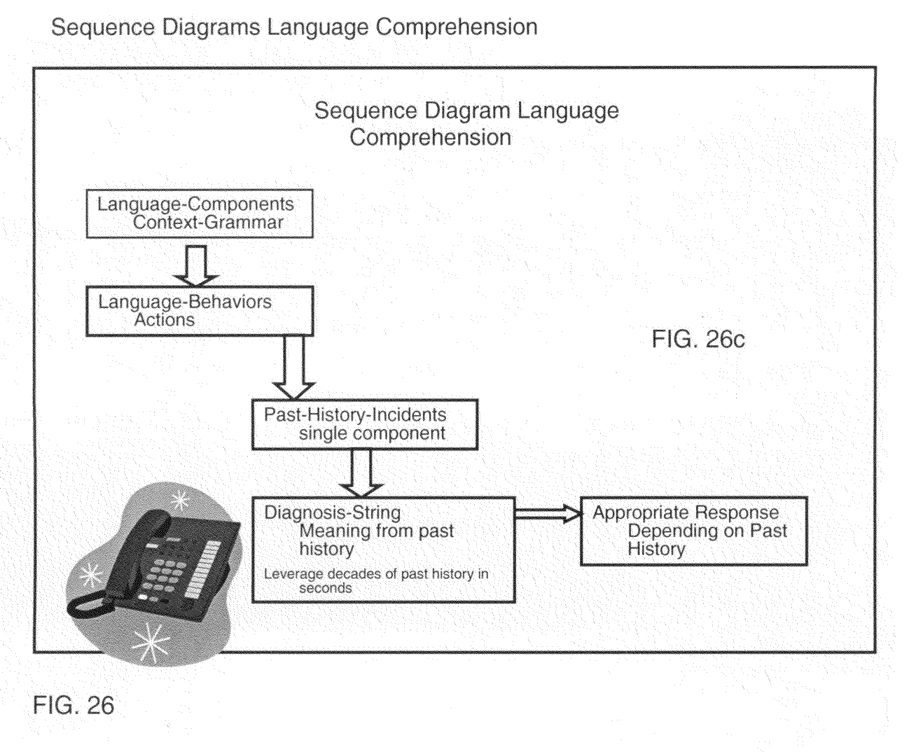

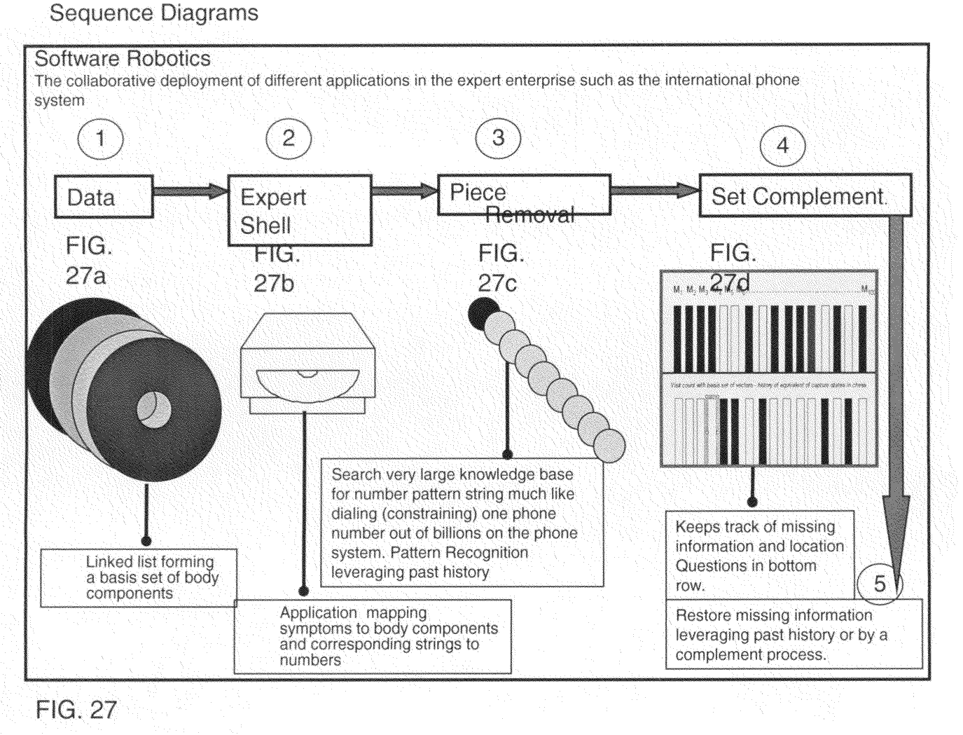

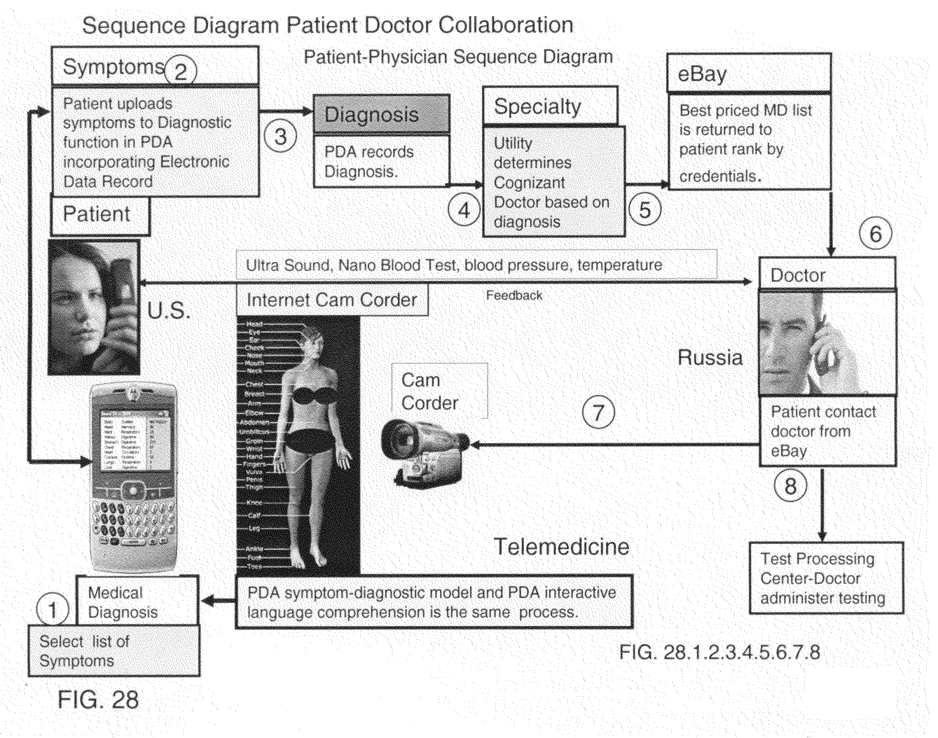

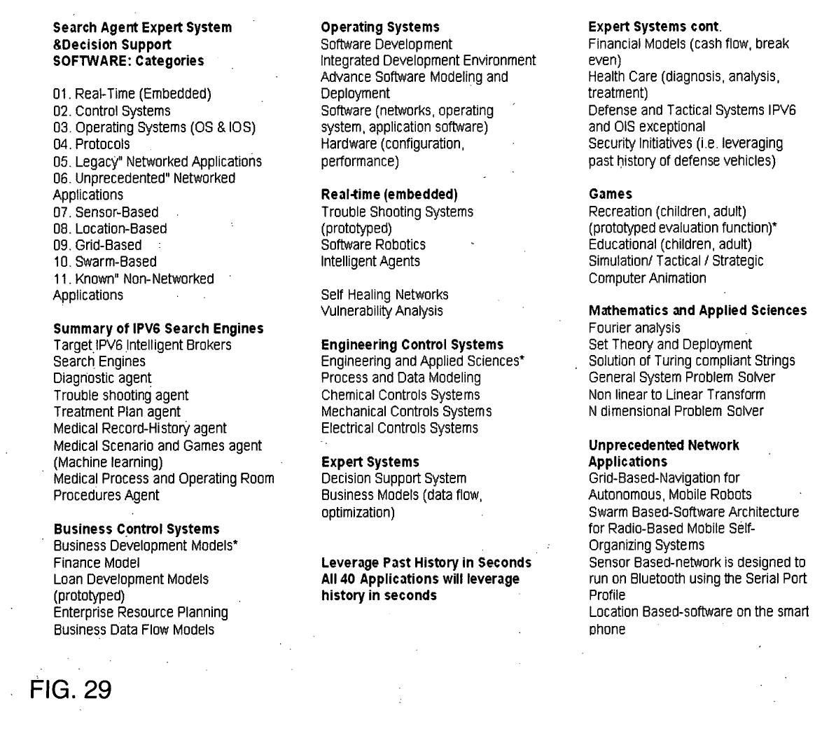

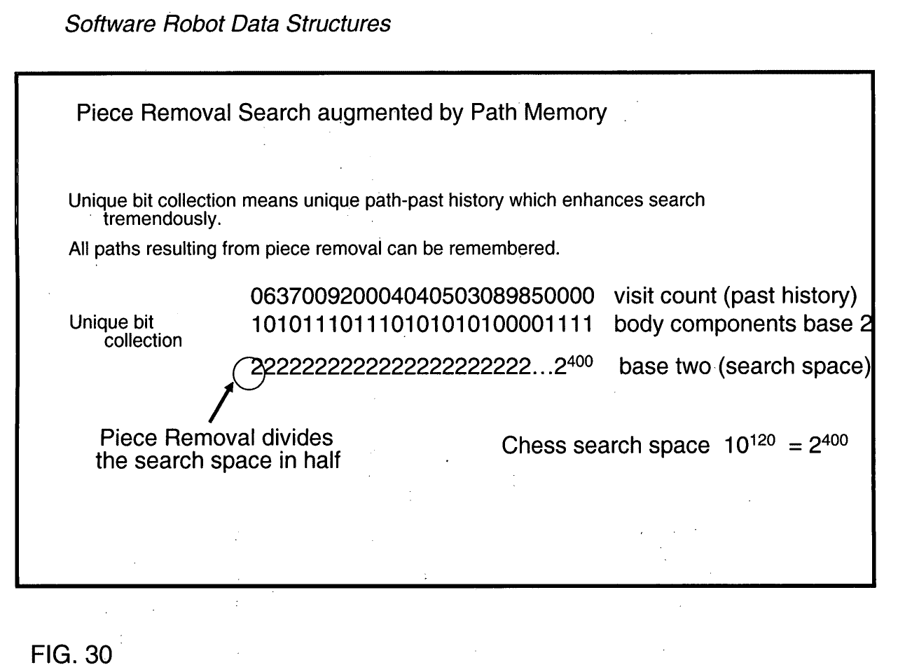

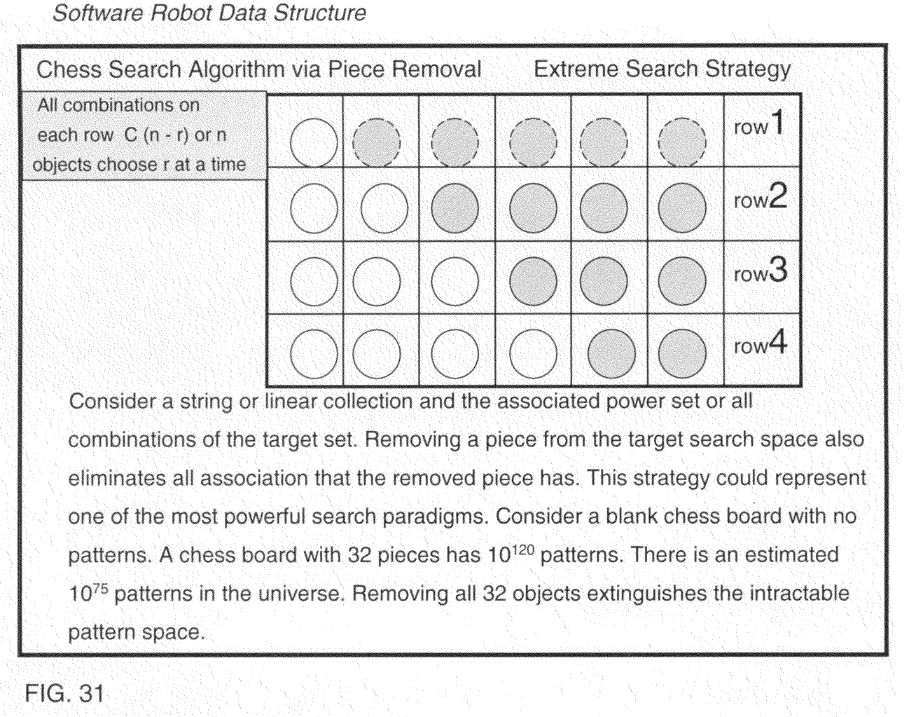

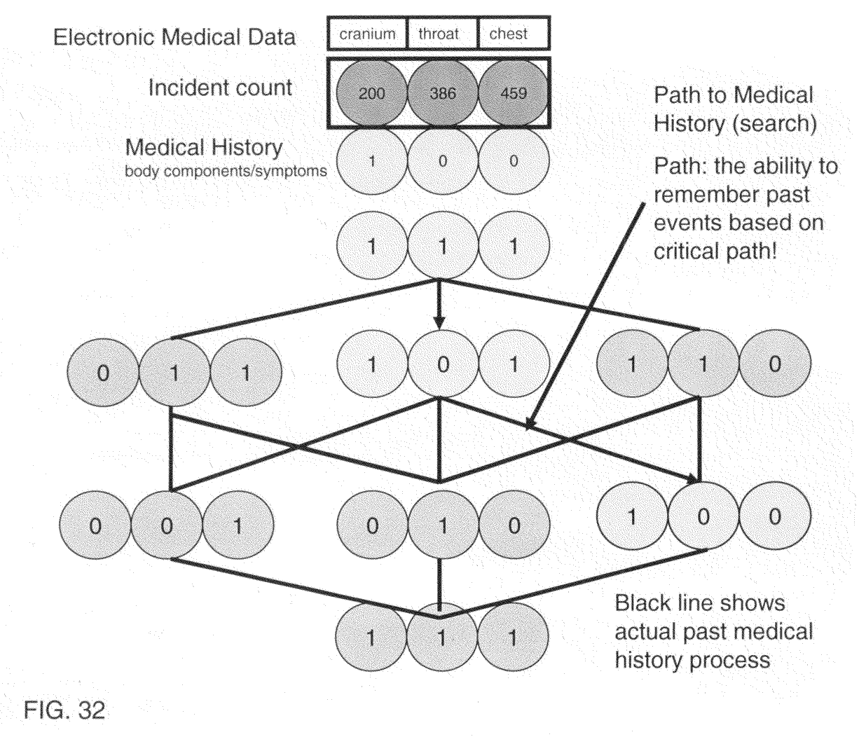

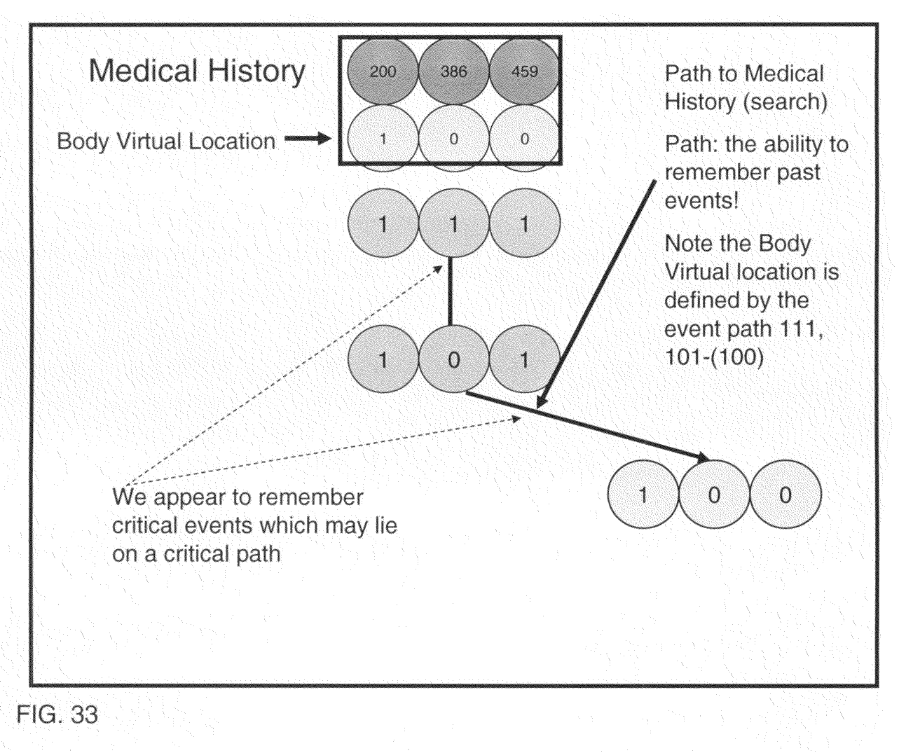

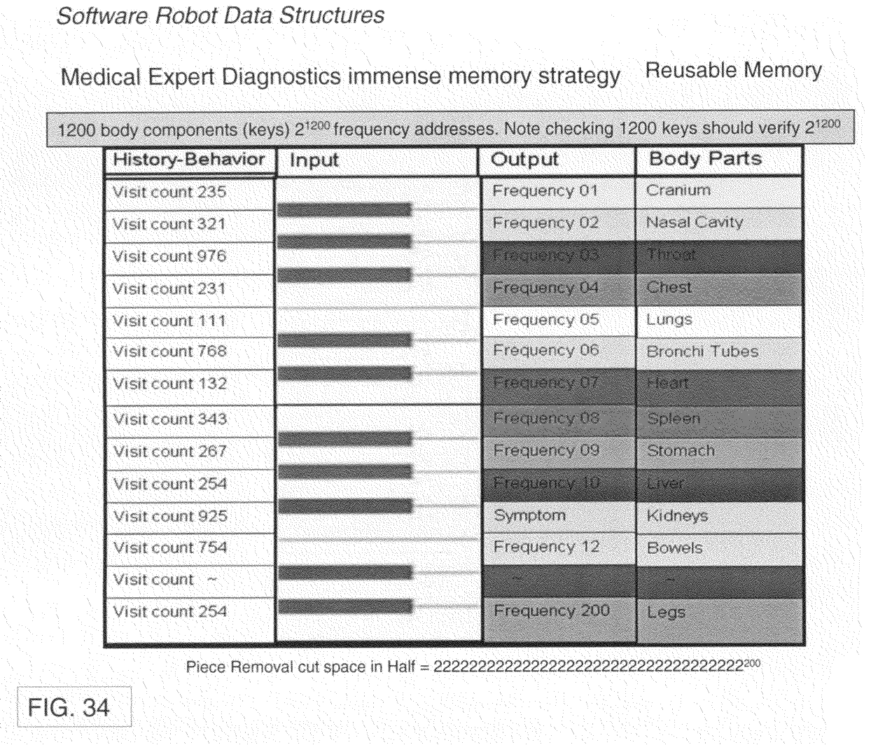

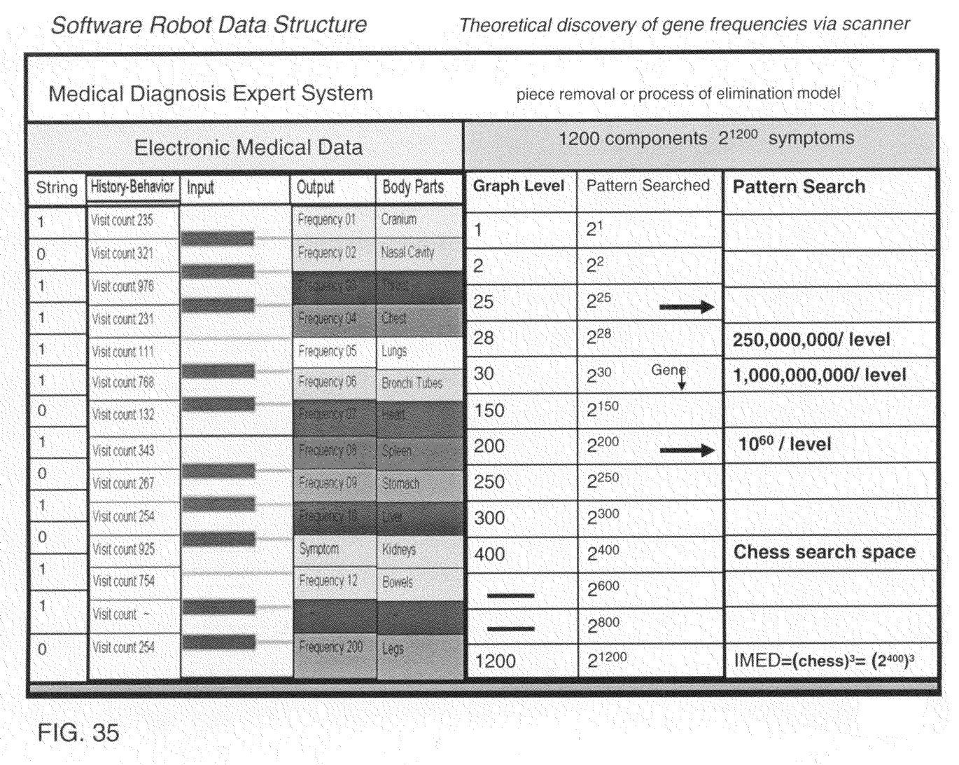

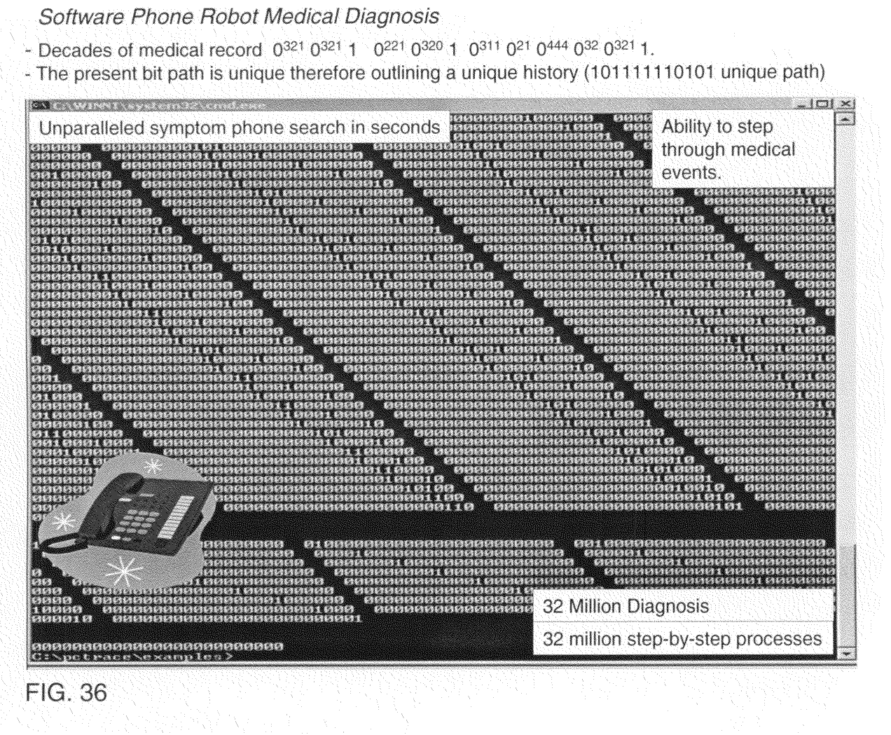

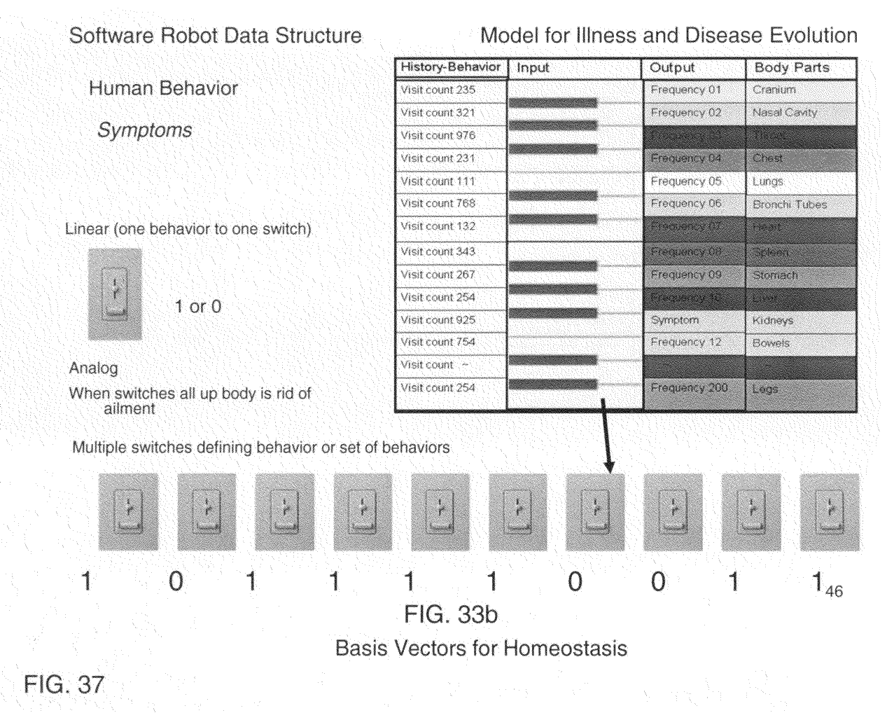

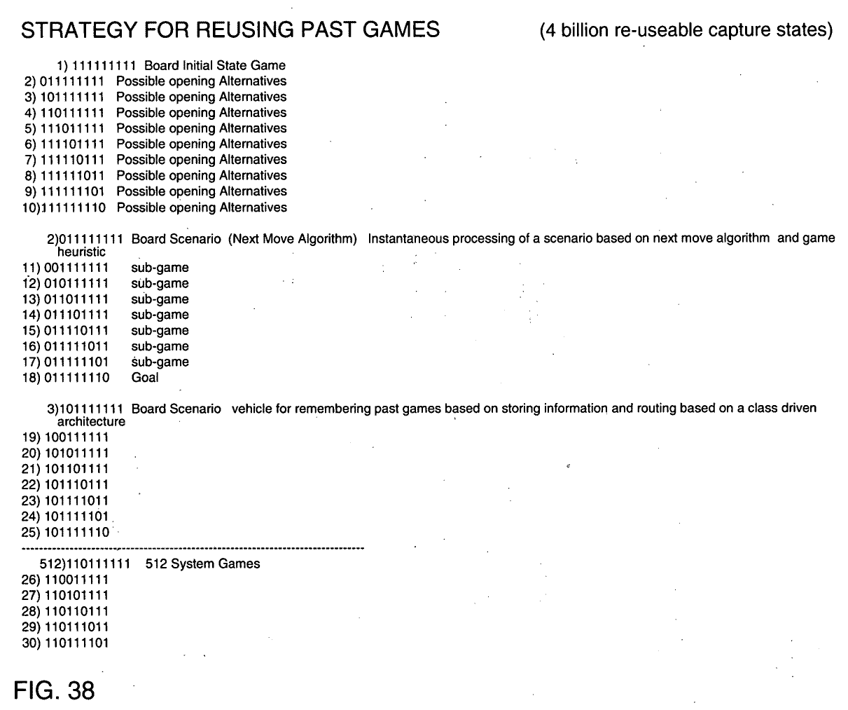

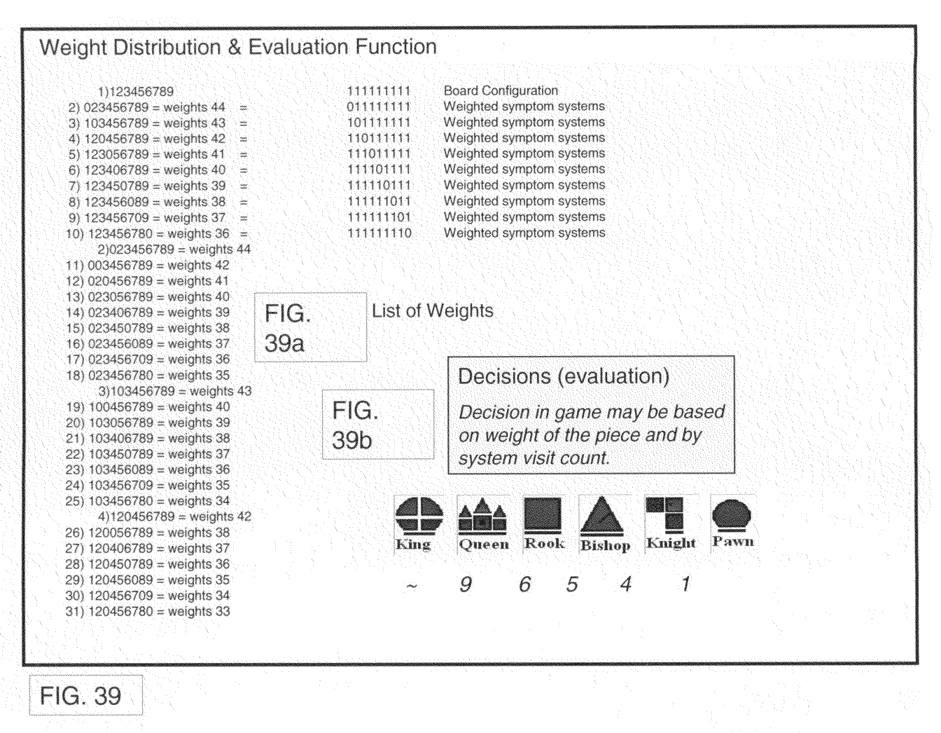

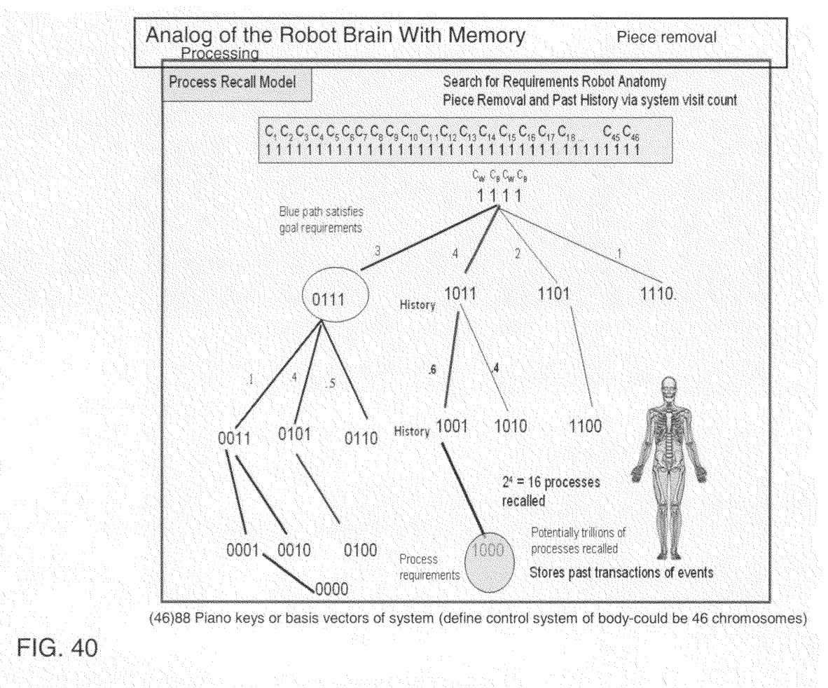

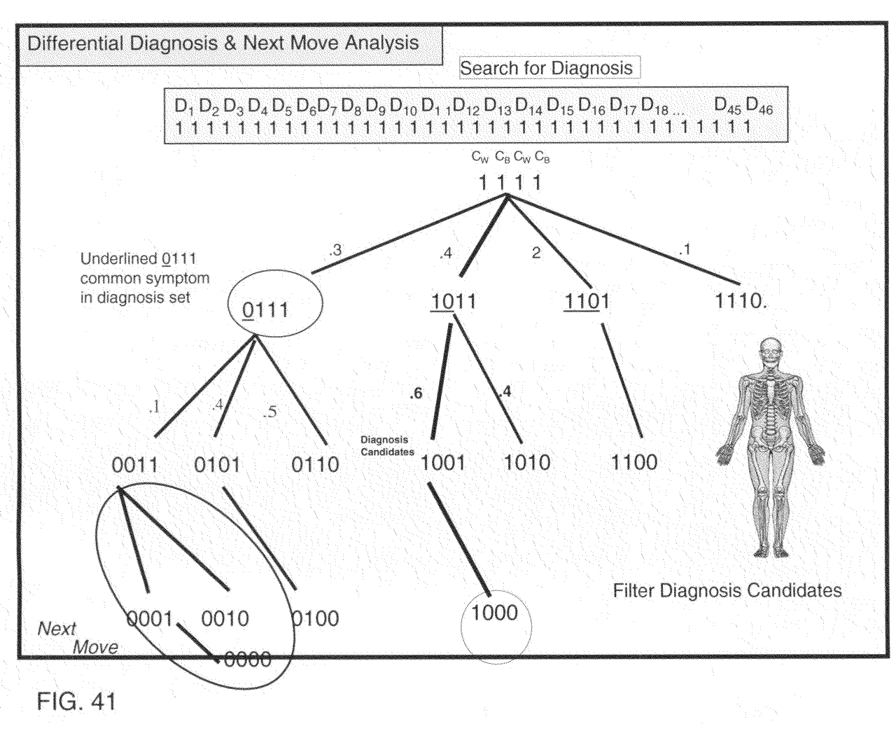

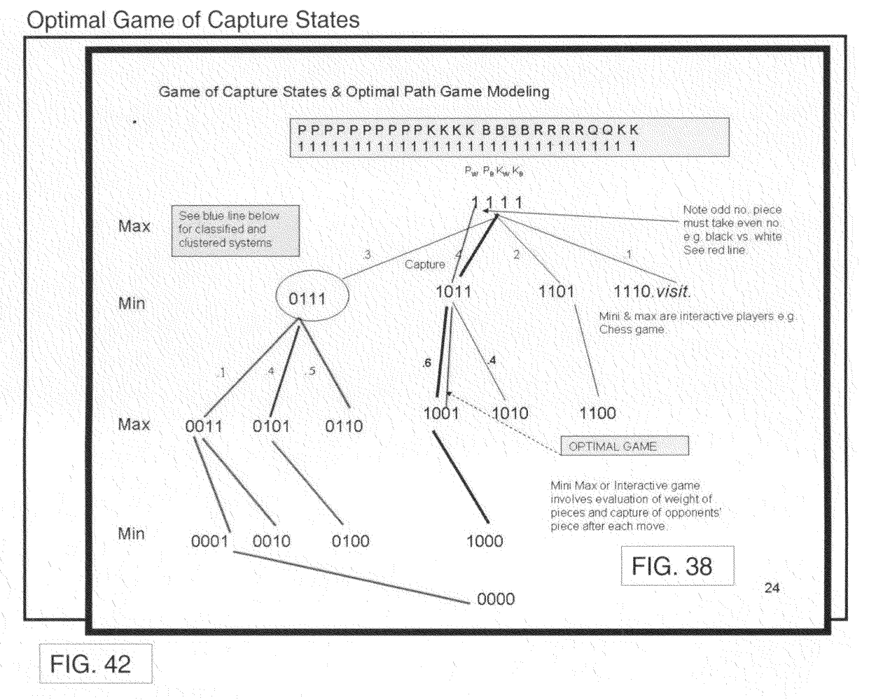

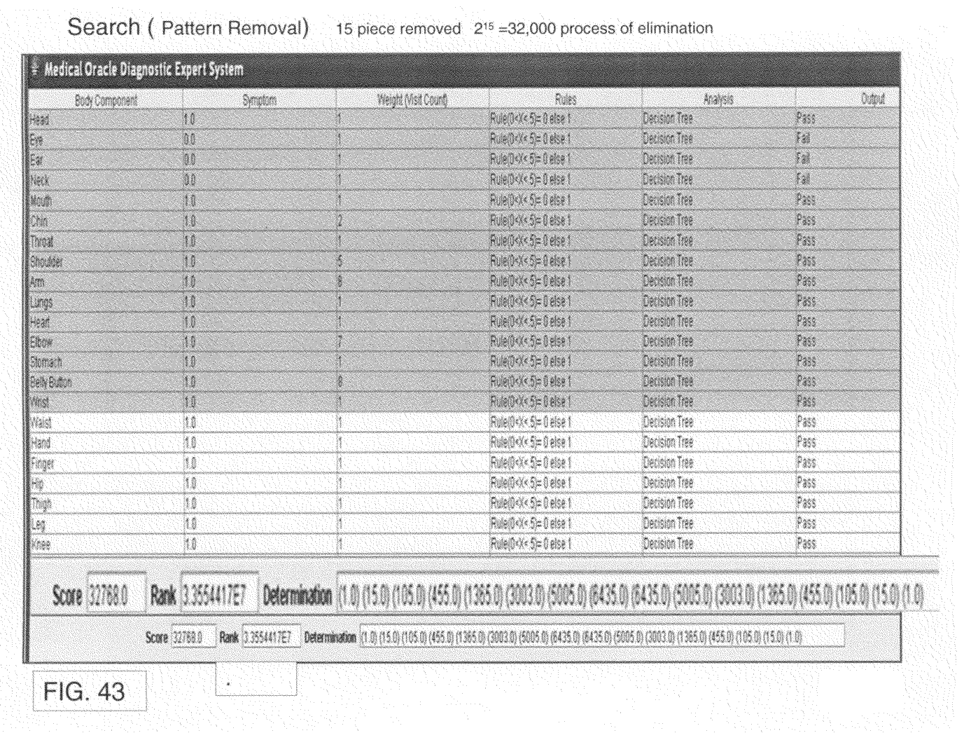

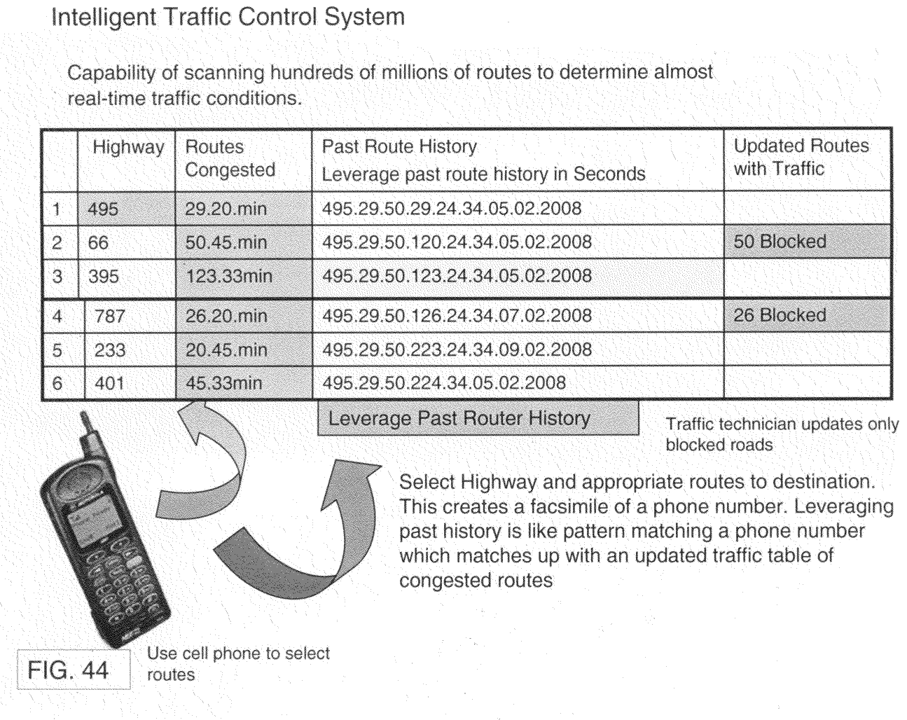

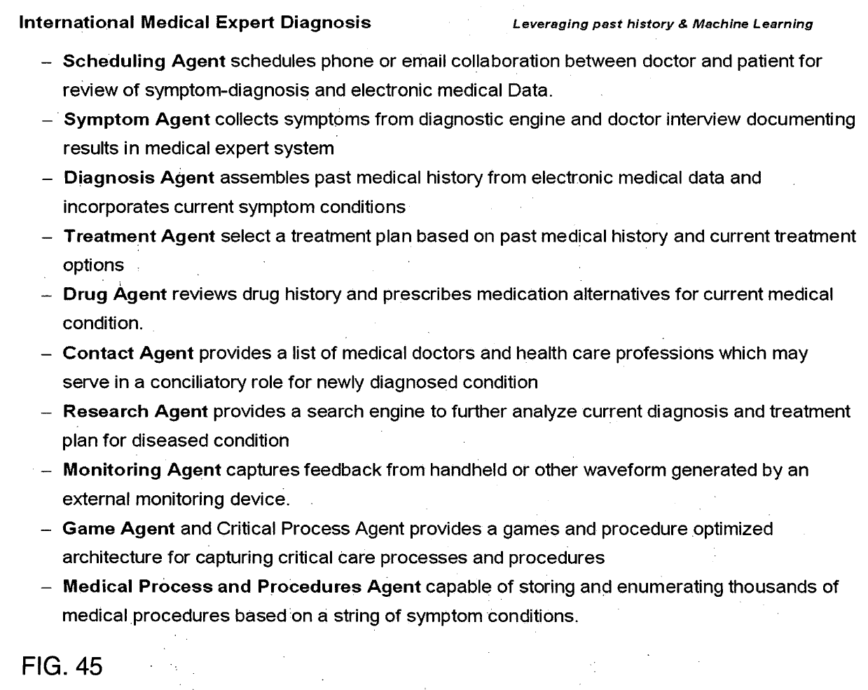

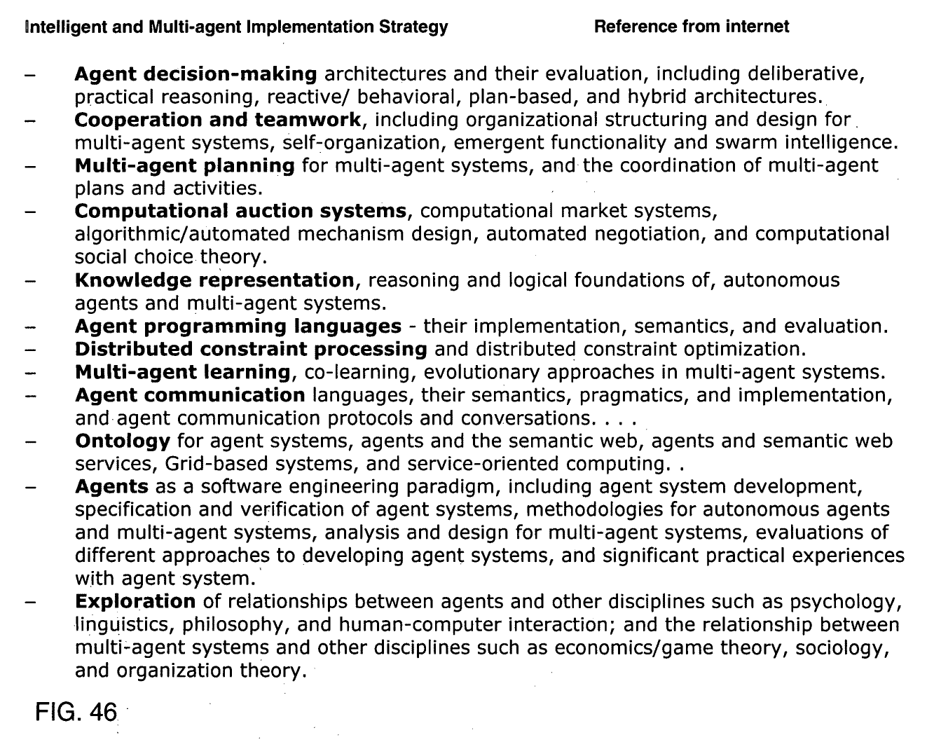

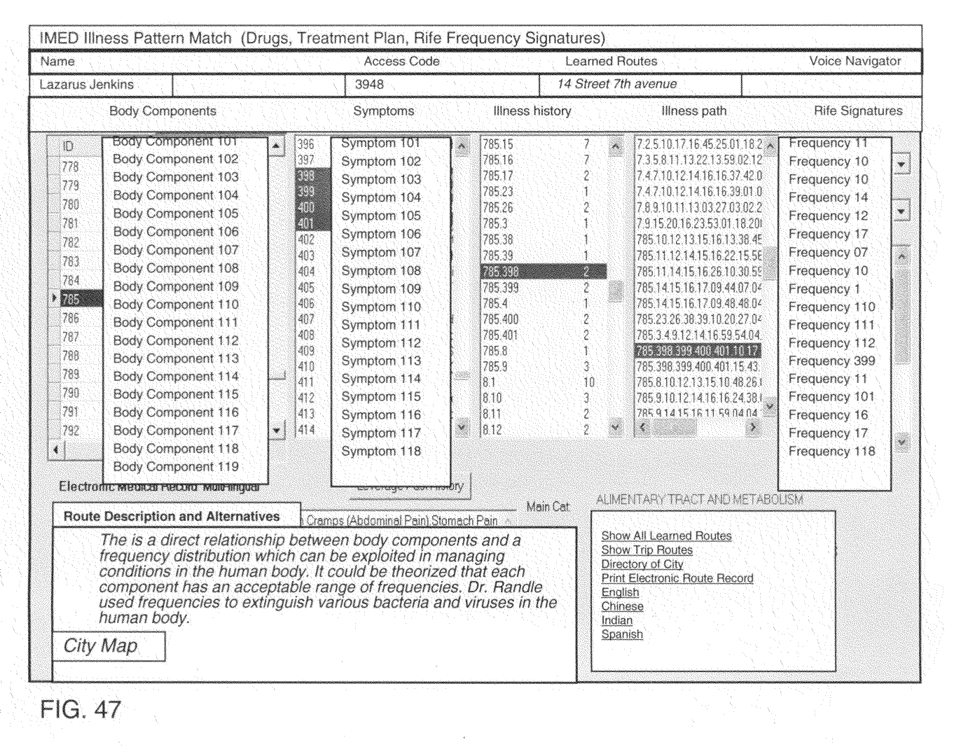

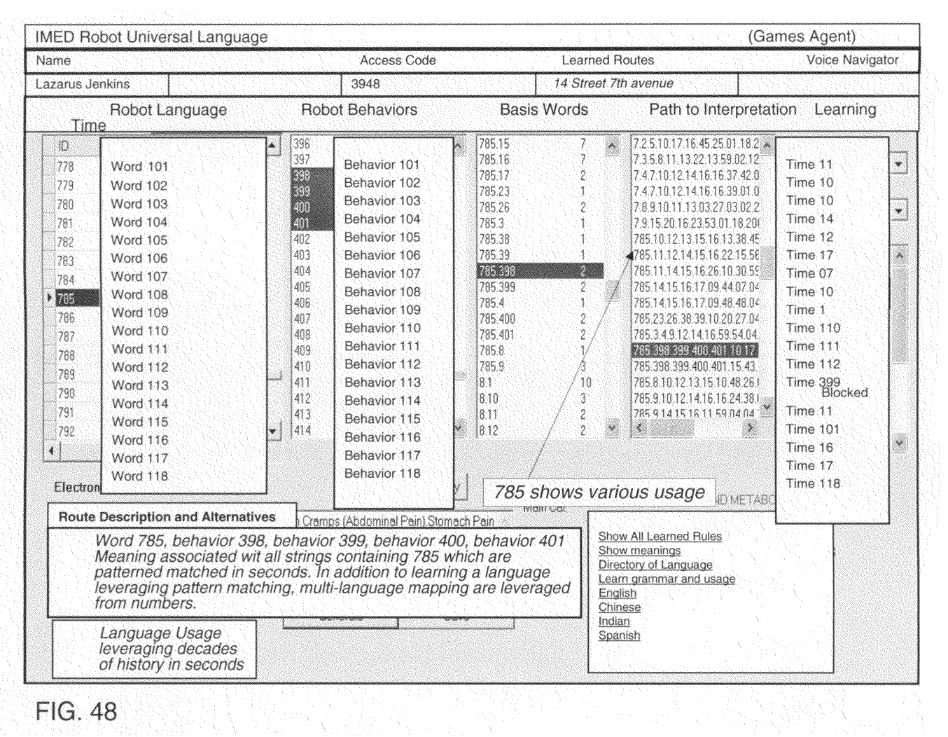

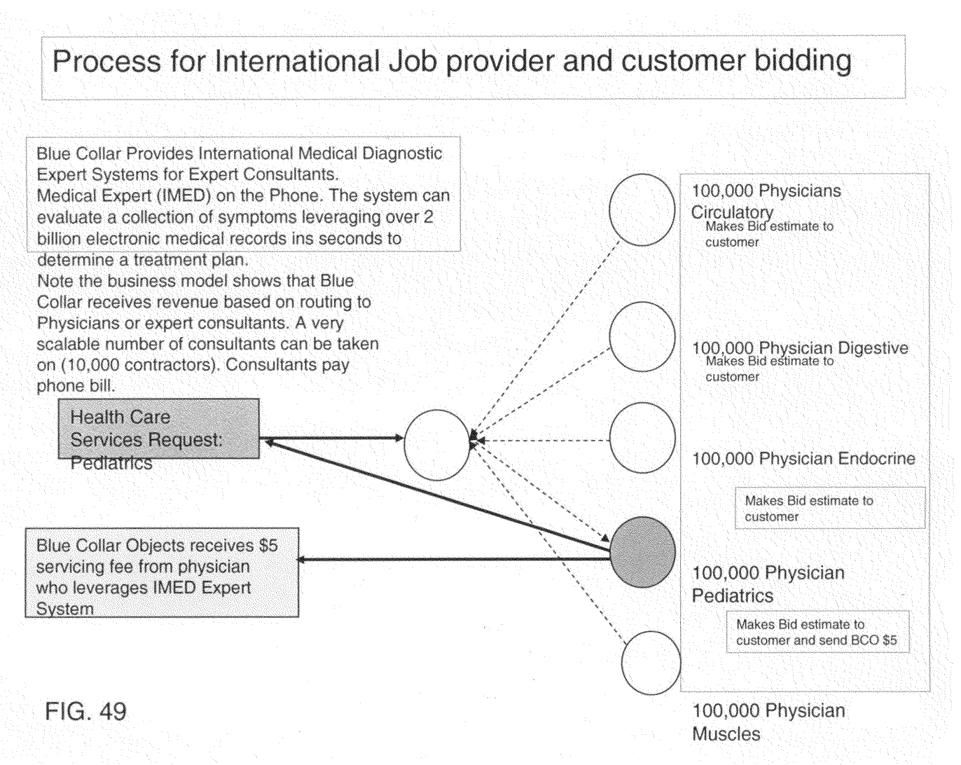

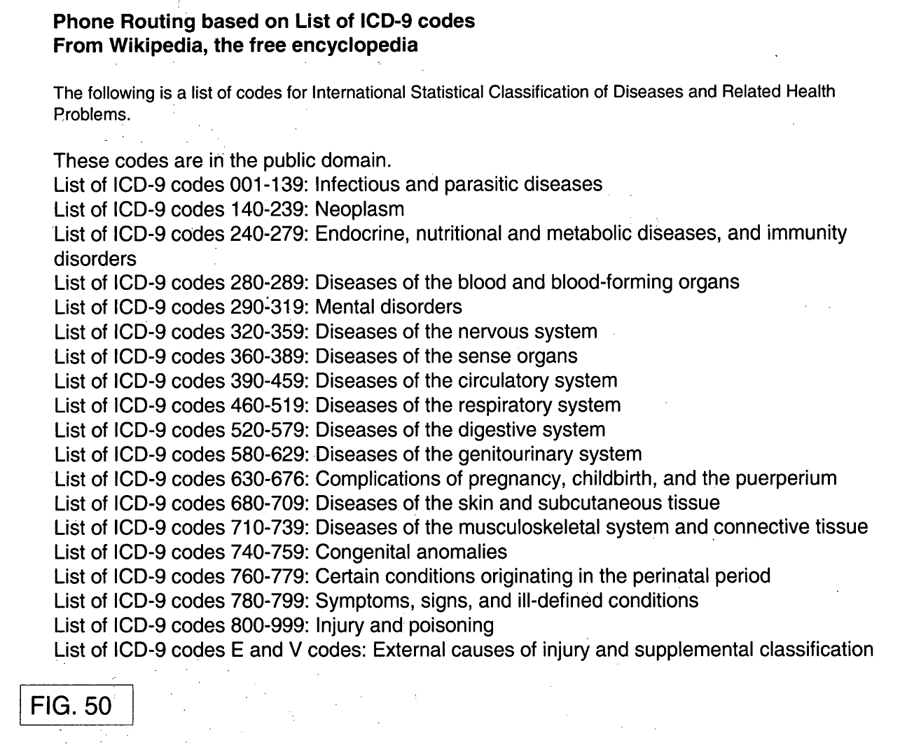

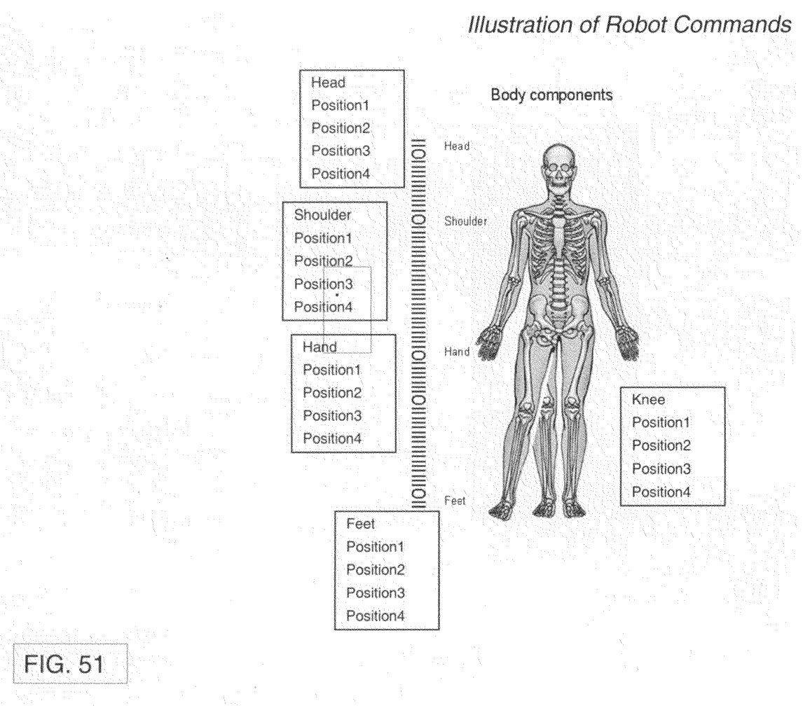

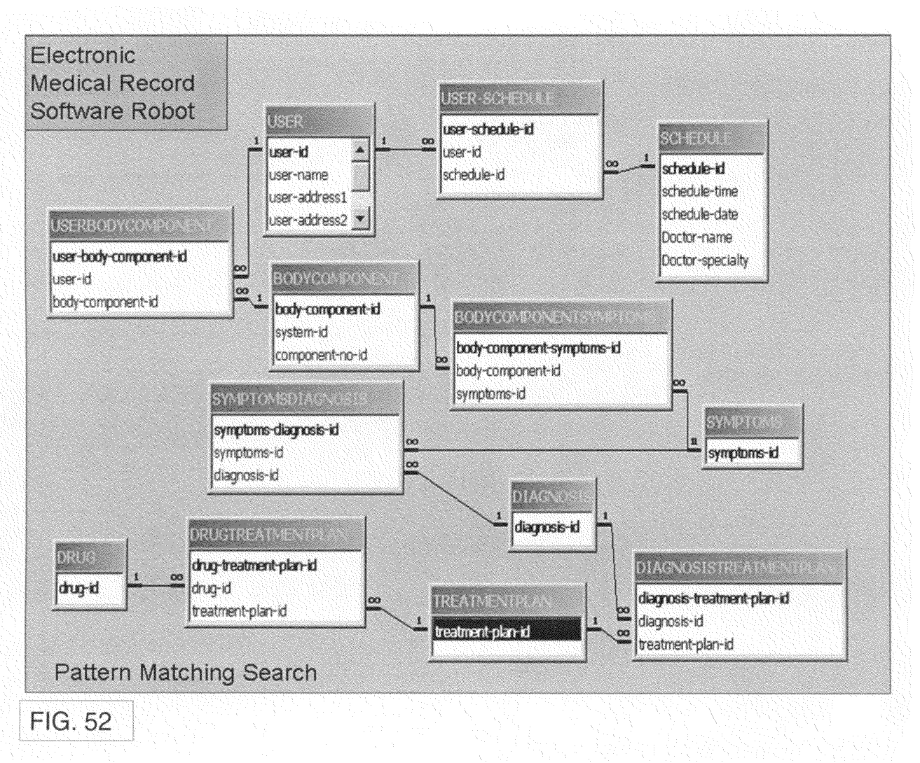

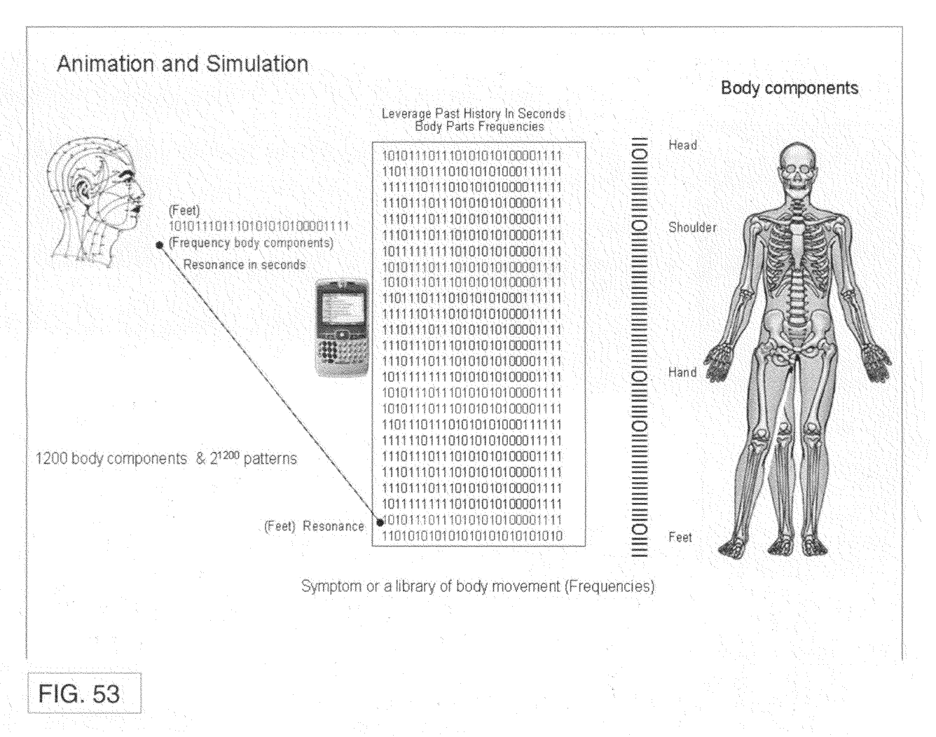

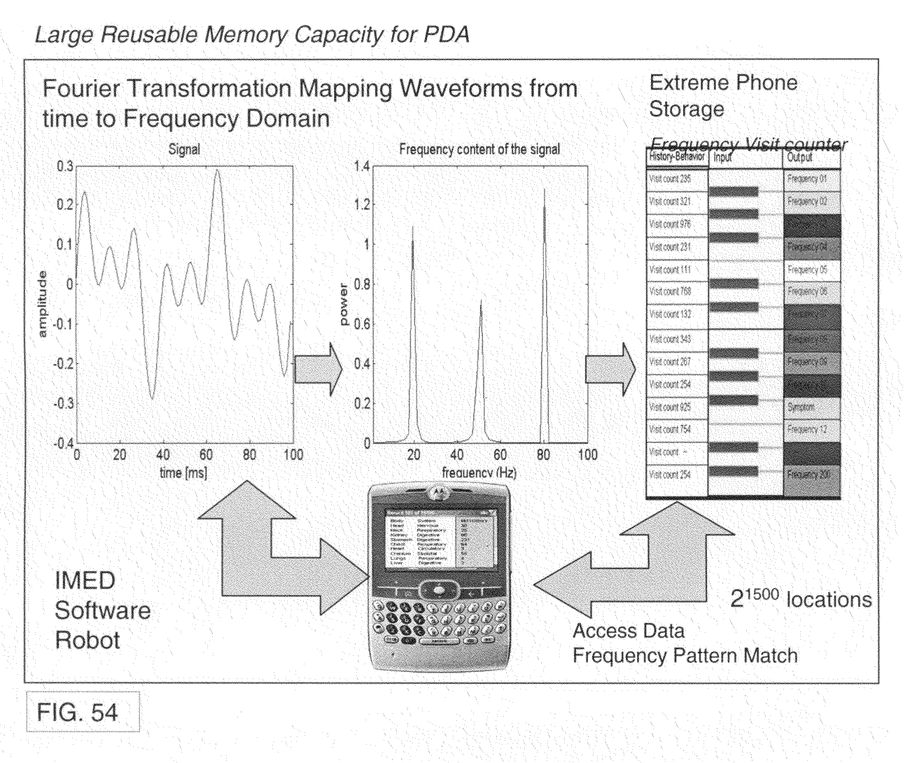

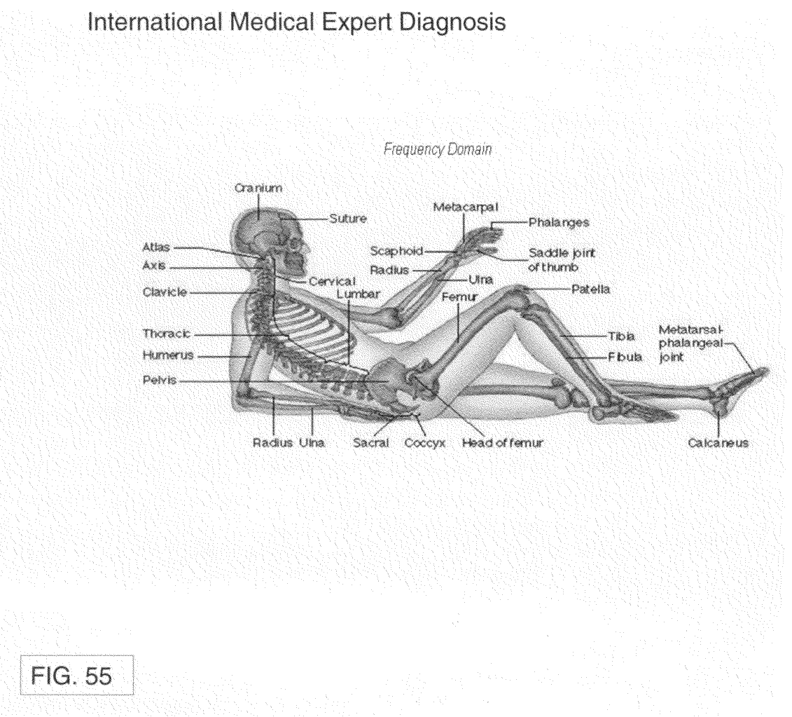

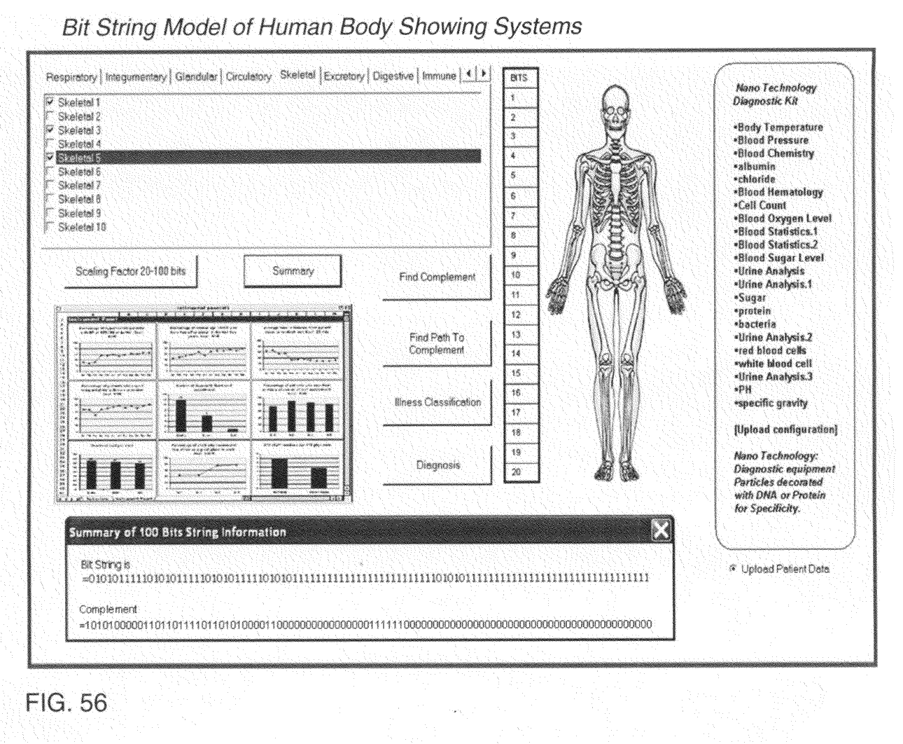

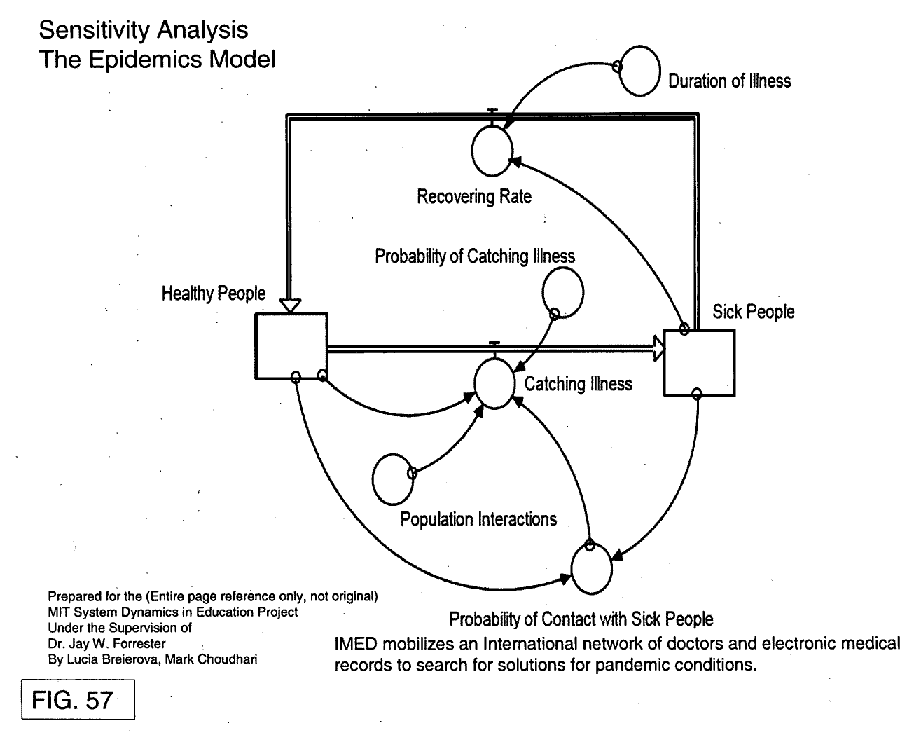

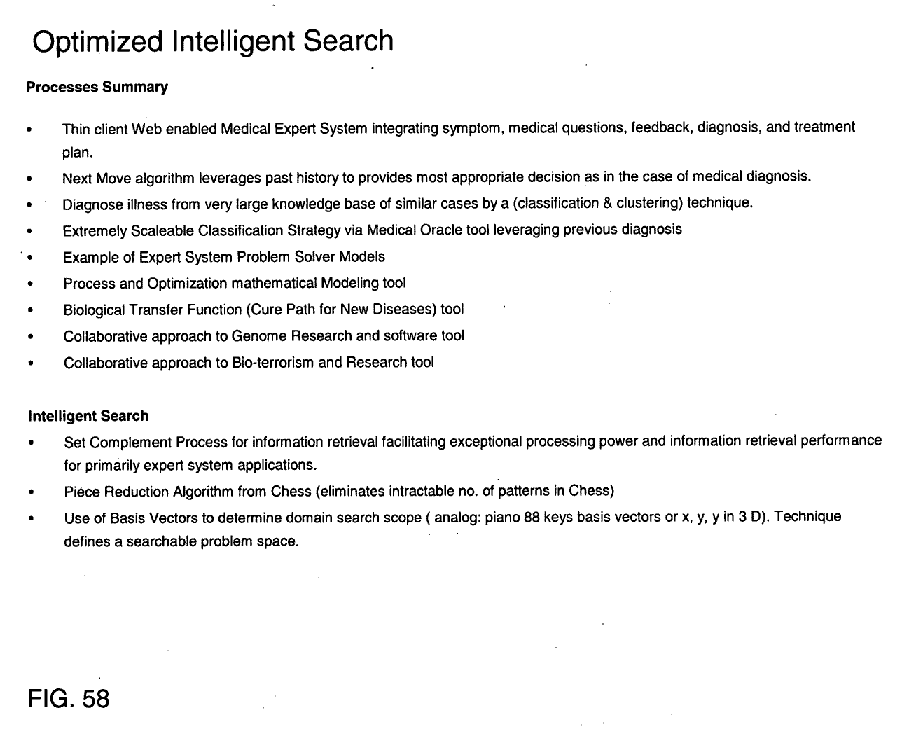

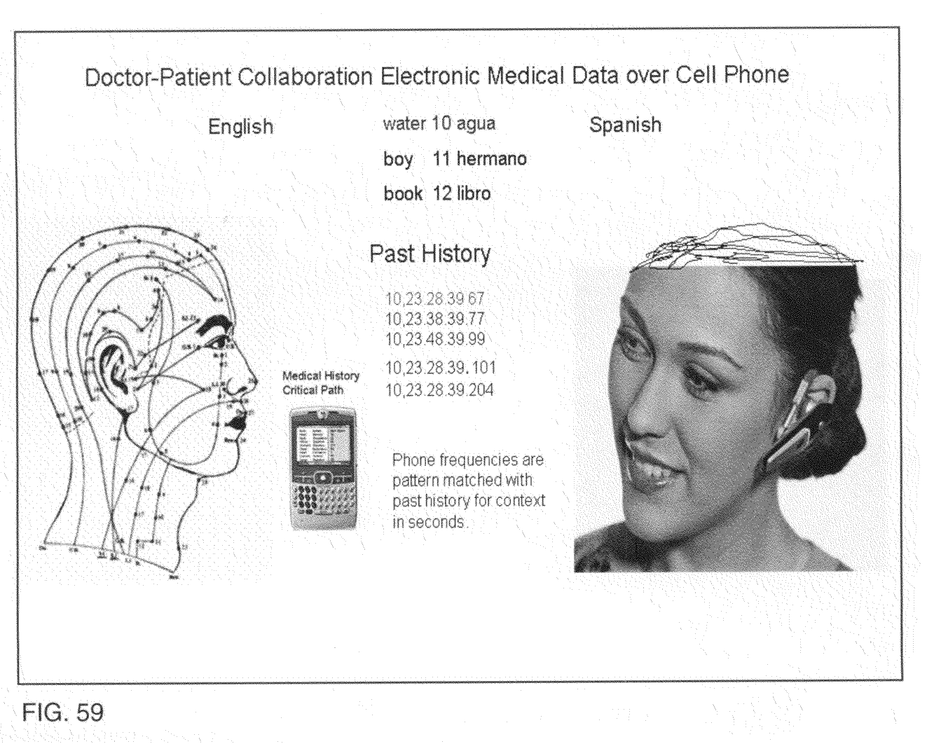

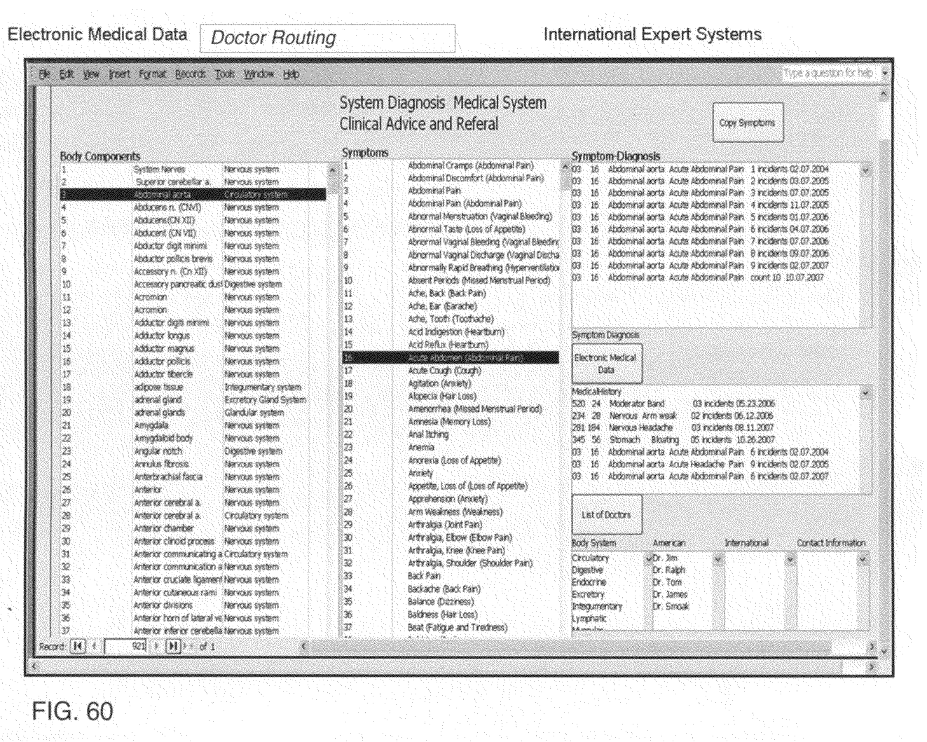

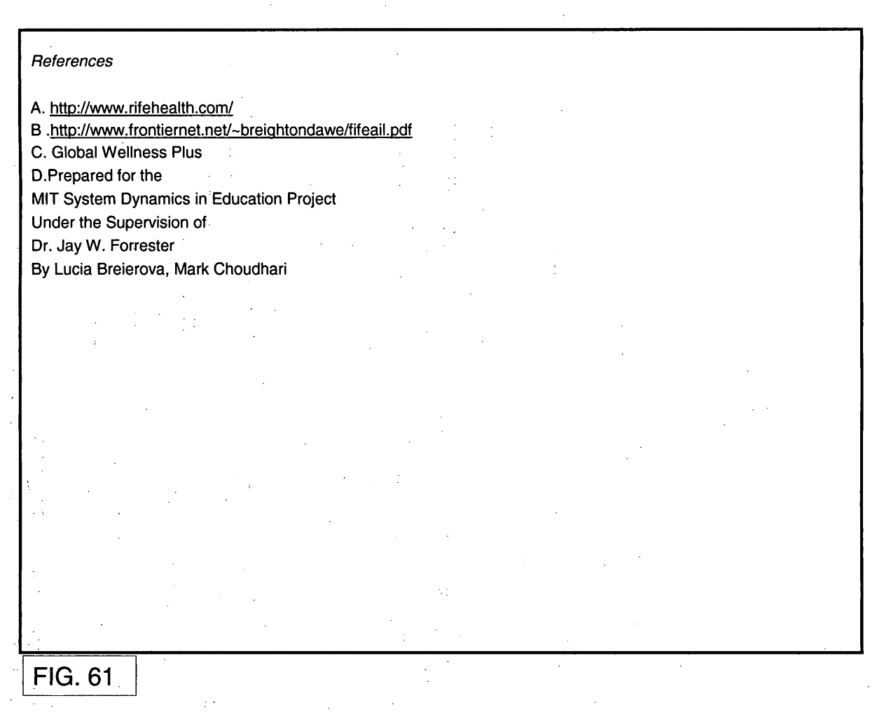

9. A method providing a system or medical question process leveraging past medical history in seconds based on a collection or bits string of ones (1) of over 1000 components representing body homeostasis as symptom in this collection are depicted as zeros (0) and these (0) are the source of questions in various system which will be presented to isolate the problems as the power set of the bit string represent all questions to be generated on the system and the set complement captures the set of outstanding question in a specific scenario as the act of leveraging past history provide all matching or pattern matched scenarios consistent with the system inquiry as the 1000 components are divided into over a dozen body system using piece removal, system elimination and set complement to reduce the pattern space in each system. FIG. 3, 32, 41

10. A method adapting numerical in lieu of text schemes as International Multi Lingual Design strategy as a word from different languages can be translated as numerical sets of body components, systems, symptoms, diagnosis and drug treatment numbers as numerical electronic medical record, should map to many languages as numbers, as in a table of numbers and terms, facilitating a phone search or pattern matching search strategy as Software Robot technology should be a major bridge in communicating internationally with a language friendly approach to deciphering electronic medical records and recommendations further noting that only numbers has to be sent over the wire since on the communication interface leverages a table of numbers and terms will perform the translation FIG. 6-12, 26, 45, 46 59

11. A method facilitating a very large storage capacity on a PDA and other telecommunications devices in a small footprint leveraging a piano model or a collection of basis vectors, 88 keys, spanning a vector space (all music) as the size of the data structure of the piano keys does not grow nor does the size of the memory allocated for visit count to piano key does not increase the allocated data structure storage capacity by reuse of a finite collection. (Abstract data type is long Integer piano key, long Integer piano Key. visit) as memory (88×long Integer piano key and 88×long Integer piano key. Visit) about 400 bytes.

12. A method comprising a search architecture as a piano has 88 key or 2̂88 states, only the integrity of the 88 keys needs to be robust to fundamentally assure all 2̂88 states are verifiable assuming the associating architecture can be verified see FIG. 12, 35 as this architecture provides the system repair or verification strategy.

13. A method to facilitate Business language Robot as language or word phrases translation on a on the IMED PDA expert shell process which maps associated words and expressions to numbers forming a history string much like IMED electronic medical records as word phrases are spoken or selected from the PDA their corresponding number enters the data stream forming a strings of past history that is leveraged by associating events over a number of decades providing a ranked list of expressions listing the proper grammar in by context as leveraging past history provides the most popular use of the word (word phrases). (see FIG. 48, 57, 59)

14. A method adopting differential diagnosis outlining the following strategies: This system comprising the following steps
a. Leveraging decades of past history using a symptom pattern
b. Sorting the body component list revealing body components and all corresponding body systems
c. Sorting the system field of the component list revealing body systems and all corresponding body components.
d. Review the sorted history of the past history field which indicates a body component and individual symptoms.
e. Review the sorted history of past history field to observe differential trends and similar patterns in collection of symptoms.
f. Review incident visit count for individual body component and symptom.
g. Review incident visit count for collection of symptoms (diagnosis) indicating illness propensity.
h. Review System ability to enumerate various states of a collection of symptoms.

15. Set complement strategy for system-diagnosis determination as the symptom (complement) patterns” are recorded used in a search string for pattern match of current of current illness patterns as associated visit count help to define the likelihood of postulated conditions. (see FIG. 5, 17)

16. A method using the software robots GUI design for PDA and other telecommunications interfaces for a electronic medical data application with an interface providing for the input to a medical diagnostic application specified as fields body component No. component Name, Component System, Symptom No., Symptoms, Past History (collection of electronic medical record Numbers), Incidents (visit count of components (numbers)), Electronic Medical Data (description of Past history (English), Drug see FIG. 6-12

17. A method providing for a GUI interface which is used to deploy several decision support application which leverage past history as the body component field” is augmented by a collection of frequency signatures as the IMED expert system shell could be used to maintain a library of acceptable frequency of body components (MRI, Ultrasound) as well as frequency orchestrated treatment plan. See FIG. 6-12

18. The concept of an interactive session on a phone is within reach with the IMED technology as we are referring to pattern recognition based on composing a diagnostic string as the body component is selected with several symptoms or behaviors as this string is pattern matched with past history or Electronic Medical Records based on leveraging past history in seconds where Electronic Medical Records serves as storage of past history of conditions a unique string of numbers or frequencies to each collection of symptoms as the diagnosis string uses a body component and a collection of symptoms when the diagnosis string leveraging past history, all context of aliments are listed and the best context is selected by inspection as this process outlines the data flow for originating interactive or collaborative communications on a system facilitated by being able to search through all context related history. See FIG. 5)

19. A method which implements the IMED process model which maps a collection of body symptoms to the context body part forming a string which is pattern matched with decades of electronic medical records facilitating a voice translation process resembling a modem process mapping an analog signal to a number and using this number to map the equivalent English translation from a table of English terms and their corresponding numbers in conjunction with history file spanning decades (i.e. Electronic medical record). See FIG. 59

20. A process establishing the protocols for Expert System Tool design Strategy and information definition and search heuristics data (basis vectors, set complements (system errors), search strategy pattern match facilitating reuse of previous gathered electronic medical data or system solutions “facilitating a games and process simulation modeling architecture capable of complex memory based activities based on games theory leveraging optimization of process steps, recall of process steps, cutting edge pattern matching search strategy” see FIG. 35, see FIG. 12

21. A method which defining the requirements for a software robot which include creating search strings from body components and current symptoms, leveraging decades on history in seconds using decades of electronic data records and potentially a global domain of electronic data records on the phone system, unsurpassed search ability leveraging configurable processing units called Agents facilitating learned tasks and process control measures defining at least 40 decision support systems used as reusable components for software robots or specialized search engines including movie animation facilitating multi-level analysis or system behavior as well as leveraging past history in seconds Expert System=G (p₁, p₂, p₃, p₄, p₅, p₆, p₇, p₈, p₉ . . . p₁₀, p₁₁, p₁₂, p₁₃) which provides GUI design support the multiple loading of expert profiles see FIG. 6-12. 29

22. A method comprised of diagnosing Distress or Illness
Use phone internationally with your medical history (e.g. PDA).
Select Medical assistance key
Phone Dialog
Enter list of Symptoms
Leverage decades of medical history in seconds to clarify diagnosis
Based on symptoms, system logs into IMED and contacts the appropriate medical specialty internationally.
International Doctor contacts American Doctor for licensure and U.S. policies and calls Patient.
System downloads decades of Medical History from patient phone in seconds for patient and doctor review
System informs patient and doctors of prior similar symptom cases and treatment plans using symptom search string. System recalls medical history, diagnosis, drugs, treatments and scheduled appointments.
System diagnoses extremely large number of symptom cases while leveraging decades of past medical history.
Doctors collaborate to resolve patient problem and American doctor administers treatment options. Incorporating second diagnosis process opinion. See FIG. 5

23. A method which implements an IMED Phone Robot Factory as customers call in to obtain electronic medical history and diagnosis advisory for tens of thousand of diagnosis strings that are provided by customers doctors the multi-lingual format creates a convenient processing of electronic medical data records from a large international community. Expert Health care system with services and advisory will provide first class security services using software robots and health care professionals to administer and maintain electronic medical data around the world.

24. A method leveraging the IMED expert shell as a means of tracking traffic congestion as fields: city highway, city roads, road visit count, path to destination, and destination time are used to provide a phone lookup scheme for a selected highway and road route as is entered in a phone and pattern matched to a number which indicates whether path is busy or not as a real-time look and feel as facilitated by pattern. See FIG. 7

25. A Method defining an Architecture facilitating Software Robots with Frequency Databases for the most part lives on the phone system and telecommunications infrastructure providing powerful resources access and speed all over the globe as the implementation of international Electronic Medical Records and Medical Advisory which will have very fast performance especially in FIOS (fiber optics) environment since a battalion of Software robots can extract information all over the globe and in space as the concept of a frequency database involves processing a list of basis vectors in numerical format to facilitate leveraging past history in seconds to satisfy query requests Frequency Database (Requires no Indexing via Pattern Match) see FIG. 6-12

26. A method providing a Genome tool based on an expert shell which depicts gene identifier and a collection of symptoms and traits as the utility provides for a population of individuals as well has their electronic medical data to be analyzed with the trait performing various filtering, with the ability to analyze electronic medical data for patterns as facilitating medical research and analysis such genome, biological systems simulations leveraged by pattern recognition in seconds using fifty plus symptoms in seconds since leveraging past history in seconds will lead to clarification of cause and possible treatment primarily by review prior history.

27. A method leveraging Expert Systems and Set Theory as Set theory defines Expert Systems process considering whole and part relationships as an Expert system provides a whole set of basis vectors that spans a vector space leveraging the ability to query any subset of the whole at stealth speeds or leverage centuries of past history in search as this can be demonstrated on the phone system or a few pieces of pies making up whole or part scenarios as software robots leverage the ability to answer questions, solve problems leveraging past history in seconds and remember thousands of processes.

28. A process for International Doctor Consortium involving a process to obtain election of doctors based on numerical diagnosis and electronic medical record conditions, pricing, language preference, scheduling, as a multi lingual electronic record is provides greater flexibility for candidate physicians to participate and communicate with patient. see FIG. 52

29. A method deriving basis vectors from error models building basis vectors, medical-record error past history per FIG. (0) define the basis vector for the error system which is used to formulate the electronic medical record which collectively define the behavior of the system FIG. (3) as symptom or error models for IMED electronic medical records map integer number to medical conditions defining a very small foot print representation of what is required to achieve homeostasis.

30. A method for a software robot with animation, as a data model comprising tables of animation characters comprised of sequences of numbers (e.g. 785, 2, 5, 8, 9), as these collections represent a set of behaviors or actions executable almost instantaneously, providing a platform for decisions and reacting to conditions in games or actions triggered by a frequency driven controller device, providing process control or sequence of events, remembering the sequence of steps or process traversed as an architecture which recalls all process paths FIG. 51, 52, 53

31. A method capturing the process for a software robot seamlessly leveraging past history in seconds comprising, language, grammar, prior incidents and dozens of other intelligent processes instantaneously, when responding to requests or making imminent decisions as it defines a foundational case with regard to intelligent process modeling which includes language translation and leveraging of history in seconds by gather appropriate input frequency signatures and pattern matching over intractably large search space to identify past history revealing prior solutions (grammar, process, and learning)

32. A method implementing a Piano Robot written in a Programming language which takes a string of ones and generates the power set of this bit string, forming at least 30 million systems which can be loaded in a word processor in order to perform search for any string of length specified as a visit count is record on each system queried as this system provides close to minimum but sufficient architecture to recognize patterns and learn by visit count or entropy leveraging pattern matching past history in seconds as electronic records are defined as a collection of bits of length n with a system counter representing a mapping of any list which needs to be stored leveraging the piano model and retrieved by pattern matching or leveraging past history in seconds as system errors define electronic records and entire record is shown in FIG. 19, see FIG. 18, 19, 36.

33. A method comprising of a Piece Removal search process for reducing pattern space in order to find and constrain objects in intractably large search spaces, in decision support, gaming, trouble shooting, and other searching in state space see FIG. 30, 31, 40, 41, 42, 43

34. The innovation in the Language Robot involves leveraging all available history frequency signatures in order to establish context and meaning of word phrases. The system is designed to capture all spoken language ultimately comparing and leveraging all past phrases. This should add a substantial sophistication to language translation and interpretation if all words are place in a specific context and historical reference. Please focus on the number 785 from the stomach context. In the vernacular of medicine all cases of 785 could be differential diagnosis. In our current language context, the 785 class represents all occurrences from decades of past history that a phrase began with the word stomach thereby capturing all relevant context. I believe with proper focus and study one could define the necessary rules for language translation and interpretation by telephone software robots.
